(19) United States
(12) Patent Application Publication
(10) Pub. No.: US 2024/0238706 A1
(43) Pub. Date: Jul. 18, 2024

(54) FILTER HEAD, FILTER AND FILTER ASSEMBLY

(71) Applicant: 3M INNOVATIVE PROPERTIES COMPANY, St. Paul, MN (US)

(72) Inventors: Biyong QIU, Shanghai (CN); Dian ZHENG, Woodbury, MN (US); Jon KRAGNESS, Farmington, MN (US)

(21) Appl. No.: 18/554,373

(22) PCT Filed: Apr. 8, 2021
(86) PCT No.: PCT/CN2021/085865

§ 371 Date: Oct. 6, 2023

(51) Int. Cl. B01D 35/157; B01D 29/11; B01D 29/56; B01D 35/30; B01D 61/02

(52) U.S. Cl. CPC B01D 35/1573; B01D 29/114; B01D 29/56; B01D 35/30; B01D 61/025; B01D 2201/167; B01D 2201/303

(57) ABSTRACT

The present disclosure relates to a filter head (20, 20A, 20B), a filter (1) and a filter assembly (100, 200). The filter head (20, 20A, 20B) includes: a filter head housing (30, 30A, 30B); a valve (40) mounted in an inner cavity of a housing body (31, 31A, 31B); and a filter head base (50) fixedly mounted to the filter head housing (30, 30A, 30B) so as to confine the valve (40)) in the filter head housing (30, 30A, 30B). The housing body (31, 31A, 31B) is provided with a raw water port (P1), a first water outlet port (P2) and a second water outlet port (P3). The valve (40) is configured to be rotatable relative to the filter head housing (30, 30A, 30B) to an open position or a closed position. In the open position, an inner cavity of a valve body (41) is in fluid communication with the raw water port (P1), the first water outlet port (P2) and the second water outlet port (P3). In the closed position, the inner cavity of the valve body (41) is not in fluid communication with any one of the raw water port (PI), the first water outlet port (P2) and the second water outlet port (P3). A filter cartridge (10) can be removed and mounted without closing a fluid pipeline connected to the filter (1), and suitable sealing is provided between the valve (40) and the filter head housing (30, 30A, 30B), thereby effectively preventing backflow and mixing of fluids.

### TECHNICAL FIELD

The present disclosure relates to the field of filtration, and more specifically to a filter head for a filter, a filter having the filter head and a filter assembly having the filter.

### BACKGROUND

The content of this part provides only background information related to the present disclosure, and does not necessarily constitute the prior art.

Filters are widely used in industrial production and daily life, and are often used to filter various fluids. Water purifiers are common filters, and are widely used in household water systems to eliminate water pollution incurred by a water source, a transportation process, etc. and an effect of the same on water quality, so as to ensure safe water. A filter mainly includes a filter cartridge and a filter head. Raw water flows into the filter cartridge and is filtered by the filter cartridge, and the obtained product water then flows out from a fluid outlet of the filter head. During use of the filter, it is often necessary to, for example, periodically replace the filter cartridge according to a status of the filter cartridge so as to ensure that the filter provides effective filtration. The replacement of the filter cartridge relates to mounting and removal of the filter cartridge to and from the filter head. Firstly, valves of all of fluid pipelines of the filter generally need to be closed; then the filter cartridge is removed from the filter head, and a new filter cartridge is mounted to the filter head. Backflow and mixing of fluids in different fluid pipelines need to be prevented during the mounting of the filter cartridge to the filter head.

Therefore, a novel filter is needed, in which mounting and removal of a filter cartridge to and from a filter head are simple, and the filter can provide effective isolation among different fluid pipelines.

### SUMMARY

The objective of the present disclosure is to provide an improved filter head, filter and filter assembly so as to simplify mounting and removal of a filter cartridge to and from a filter head and to effectively prevent backflow and mixing of fluids in different fluid pipelines.

Provide in an aspect of the present disclosure is a filter head, comprising: a filter head housing comprising a hollow housing body; a valve mounted in an inner cavity of the housing body, wherein the valve comprises a hollow valve body; an inner cavity of the valve body is to accommodate a fluid inlet and a fluid outlet of a filter cartridge; and a filter head base mounted to the filter head housing so as to confine the valve in the filter head housing. The housing body is provided with a raw water port, a first water outlet port and a second water outlet port in communication with the inner cavity of the housing body. The valve is configured to be rotatable relative to the filter head housing to an open position or a closed position. In the open position, an inner cavity of a valve body is in fluid communication with the raw water port, the first water outlet port and the second water outlet port. In the closed position, the inner cavity of the valve body is not in fluid communication with any one of the raw water port, the first water outlet port and the second water outlet port.

In an embodiment, a circumferential wall of the valve body is provided with a first group of through holes and a second group of through holes spaced apart from each other in an axial direction of the valve; a transverse wall of the valve body is provided with an inner cylindrical portion; the inner cylindrical portion axially extends through the transverse wall, and has a first inner cylinder portion located axially above the transverse wall; the first inner cylinder portion is provided with an opening portion. In the open position, one of the first group of through holes is in fluid communication with the raw water port, one of the second group of through holes is in fluid communication with the first water outlet port, and the opening portion is in fluid communication with the second water outlet port. In the closed position, none of the first group of through holes is in fluid communication with the raw water port, none of the second group of through holes is in fluid communication with the first water outlet port, and the opening portion is not in fluid communication with the second water outlet port.

In an embodiment, the housing body is further provided with an annular wall axially extending from a top wall of the housing body into the inner cavity of the housing body; an axial end portion of the annular wall is provided with a notch; the annular wall sealedly engages with the first inner cylinder portion. In the open position, the opening portion is in fluid communication with the second water outlet port by means of the notch. In the closed position, the opening portion is completely blocked by the annular wall.

In an embodiment, one of the housing body and the valve body is provided with a first position-limiting portion, and the other one of the housing body and the valve body is provided with a second position-limiting portion; the first position-limiting portion and the second position-limiting portion jointly define a rotation range of the valve relative to the filter head housing.

In an embodiment, the opening portion comprises a first opening portion and a second opening portion spaced apart circumferentially. The notch comprises a first notch and a second notch spaced apart circumferentially, so that a first curved wall and a second curved wall spaced apart from each other circumferentially are formed on the axial end portion of the annular wall. In the open position, the first opening portion and the second opening portion are in fluid communication with the second water outlet port respectively by means of the first notch and the second notch. In the closed position, the first opening portion and the second opening portion are respectively completely blocked by the first curved wall and the second curved wall.

In an embodiment, the first position-limiting portion is a position-limiting protrusion provided on an axial end portion of the first curved wall, and the second position-limiting portion is a position-limiting recess provided on the transverse wall of the valve body.

In an embodiment, an annular first seal, an annular second seal and an annular third seal are provided between the circumferential wall of the valve body and a circumferential wall of the housing body; the first seal is located axially below the first group of through holes; the second seal is located between the first group of through holes and the second group of through holes; and the third seal is provided axially above the second group of through holes, and is located axially below the second water outlet port.

In an embodiment, each through hole of the first group of through holes and the second group of through holes is provided with an annular seal therearound.

The filter head housing further comprises a housing flange; the housing flange is located on a radial outer side of the housing body; a housing step portion is formed between the housing body and the housing flange in the inner cavity of the filter head housing; and the housing step portion and the filter head base jointly maintain an axial position of the valve.

The valve further comprises a valve flange; the valve flange is located on a radial outer side of the valve body; a valve step portion is formed between the valve body and the valve flange in an inner cavity of the valve, wherein the valve flange is mounted between the filter head base and the housing step portion.

An inner surface of a circumferential wall of the valve flange is provided with a protruding portion, and the protruding portion is configured to be operable so as to cause the valve to rotate relative to the filter head housing.

In an embodiment, the housing body is provided with a first group of tubular portions, a second group of tubular portions and a third group of tubular portions spaced apart from each other in an axial direction of the housing body; one of the first group of tubular portions forms the raw water port; one of the second group of tubular portions forms the first water outlet port; and one of the third group of tubular portions forms the second water outlet port.

In an embodiment, the raw water port, the first water outlet port and the second water outlet port are axially aligned with one another.

In an embodiment, an outer circumferential wall of the housing body is provided with a rib portion circumferentially extending thereon.

The rib portion comprises a first annular rib and a second annular rib, the first annular rib is provided between the first group of tubular portions and the second group of tubular portions, and the second annular rib is provided between the second group of tubular portions and the third group of tubular portions; and/or the rib portion comprises curved ribs circumferentially extending on the outer circumferential wall of the housing body between the tubular portions of each group of the first group of tubular portions, the second group of tubular portions and the third tubular portions.

In an embodiment, the first group of tubular portions, the second group of tubular portions, the third tubular portions and the rib portion of the housing body are integrally formed by means of injection molding.

Another aspect of the present disclosure is to provide a filter comprising a filter cartridge, and the filter cartridge is provided with a fluid inlet and a fluid outlet. The filter further comprises the filter head according to the present disclosure. The fluid inlet and the fluid outlet of the filter cartridge are mounted in the inner cavity of the valve body of the filter head; the fluid inlet is in fluid communication with the raw water port; and the fluid outlet is in communication with one or both of the first water outlet port and the second water outlet port.

In an embodiment, the fluid outlet comprises a first fluid outlet and a second fluid outlet; the first fluid outlet is in fluid communication with the first water outlet port; and the second fluid outlet is in fluid communication with the second water outlet port.

The filter cartridge is provided with a retaining recess, and the retaining recess engages with the protruding portion of the valve so that the valve can rotate with the filter cartridge to the open position or the closed position.

The filter cartridge is provided with a mounting portion; an inner wall of the filter head base is provided with a retaining portion; when the valve rotates with the filter cartridge, the mounting portion moves along the retaining portion; in the open position, the mounting portion is confined between the retaining portion and a valve step portion of the valve; and in the closed position, the mounting portion leaves the retaining portion.

In an embodiment, the retaining recess is provided on the mounting portion.

Still another aspect of the present disclosure is to provide a filter assembly comprising a plurality of filters according to the present disclosure, wherein the plurality of filters is fluidly connected to each other.

The plurality of filters comprises a first filter and a second filter, and the filter assembly is provided with: a water inlet connected to a raw water port of the first filter; a first water outlet connected to a second water outlet port of the first filter; a second water outlet connected to a first water outlet port of the second filter; and a third water outlet connected to a second water outlet port of the second filter. A first water outlet port of the first filter is connected to a raw water port of the second filter.

In an embodiment, the plurality of filters further comprises a third filter.

One of the raw water port, the first water outlet port and the second water outlet port of the second filter is in fluid communication with a raw water port of the third filter.

In an embodiment, the raw water port of the second filter is in fluid communication with the raw water port of the third filter; a first water outlet port of the third filter is connected to the second water outlet; a second water outlet port of the third filter is connected to the third water outlet.

In an embodiment, a filter cartridge of the first filter is a pre-filtration composite filter cartridge, and a filter cartridge of the second filter is a reverse osmosis membrane filter cartridge.

In the present disclosure, the valve is provided in the filter head housing, the fluid inlet and the fluid outlet of the filter cartridge are mounted in the valve, and the valve is configured to be capable of rotating relative to the filter head housing to the open position or the closed position to cause the raw water port, the first water outlet port and the second water outlet port of the filter head to fluidly or not fluidly communicate with the inner cavity of the valve so as to remove or mount a filter cartridge without closing a fluid pipeline connected to the filter or the filter assembly; in addition, suitable sealing is provided between the valve and the filter head housing, thereby effectively preventing backflow and mixing of fluids.

### BRIEF DESCRIPTION OF THE DRAWINGS

Embodiments of the present disclosure are described below merely as examples with reference to the accompanying drawings. In the accompanying drawings, the same features or components are represented by the same reference numerals, and the accompanying drawings are not necessarily drawn to scale. Further, in the accompanying drawings:

FIG. 1 shows a cross-sectional view of a filter according to a first embodiment of the present disclosure;

FIG. 2 shows a partial enlarged view of a filter in FIG. 1;

FIG. 3 shows a partial perspective view of a filter cartridge of a filter in FIG. 1;

FIG. 4 and FIG. 5 show partial cutaway perspective views of a filter head of a filter in FIG. 1;

FIG. 6 shows a partial perspective view of a filter head of a filter in FIG. 1;

FIG. 7 to FIG. 9 respectively show perspective views of a valve of a filter head in FIG. 4 and FIG. 5 taken from different angles;

FIG. 10 shows a perspective view of a filter head in FIG. 4 and FIG. 5;

FIG. 11 shows a cross-sectional view taken along a section line A-A in FIG. 4;

FIG. 12 shows a cross-sectional view taken along a section line C-C in FIG. 11;

FIG. 13 shows a cross-sectional view taken along a section line B-B in FIG. 5;

FIG. 14 shows a cross-sectional view taken along a section line D-D in FIG. 13;

FIG. 15 shows a cross-sectional view of a filter head of a filter according to a first modification example of the present disclosure;

FIG. 16 shows a cross-sectional view of a filter head of a filter according to a second modification example of the present disclosure;

FIG. 17 shows a cross-sectional view of a filter assembly according to the present disclosure;

FIG. 18 shows a partial cross-sectional view of a filter cartridge of a filter assembly in FIG. 17;

FIG. 19 shows a cross-sectional view of another filter assembly according to the present disclosure; and

FIG. 20 shows a partial enlarged view of FIG. 19.

### DETAILED DESCRIPTION

The following description is merely exemplary in nature and is not intended to limit the present disclosure, applications, and uses. It should be understood that in all of the accompanying drawings, similar reference numerals represent the same or similar parts and features. The accompanying drawings illustratively show the idea and principles of the embodiments of the present disclosure, but do not necessarily show specific size of each embodiment of the present disclosure and the scale thereof. In some parts of specific accompanying drawings, related details or structures of the embodiments of the present disclosure may be illustrated in an exaggerated manner.

In the descriptions of the embodiments of the present disclosure, the directional terms related to “up” and “down” are described according to the upper and lower positions in the views shown in the accompanying drawings. In an actual application, the “up” and “down” position relationships used in the present disclosure may be defined according to actual conditions, and these relationships can also be reversed.

A filter head according to the present disclosure can be applied to various filters and filter assemblies. A filter and a filter assembly having the filter head according to the present disclosure can be used to filter municipal tap water, and can also be used to filter other fluids. With reference to the accompanying drawings, as an example of application of a filter in a municipal tap water filtration system, the filter head and the filter having the filter head according to the present disclosure are described below.

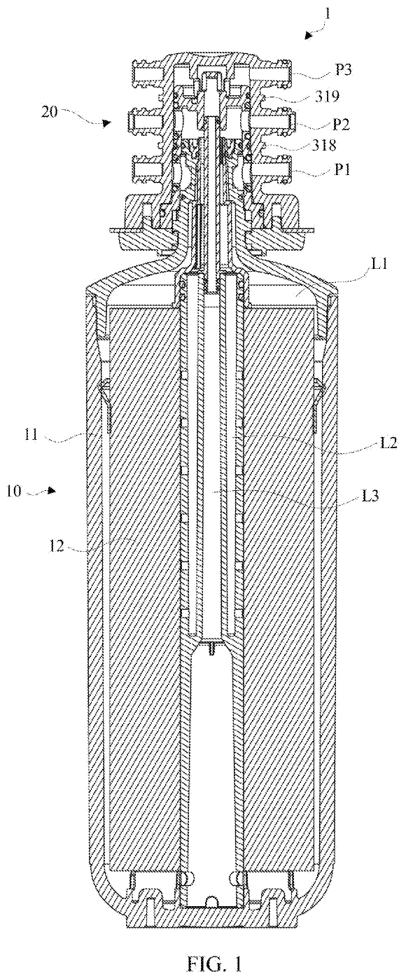

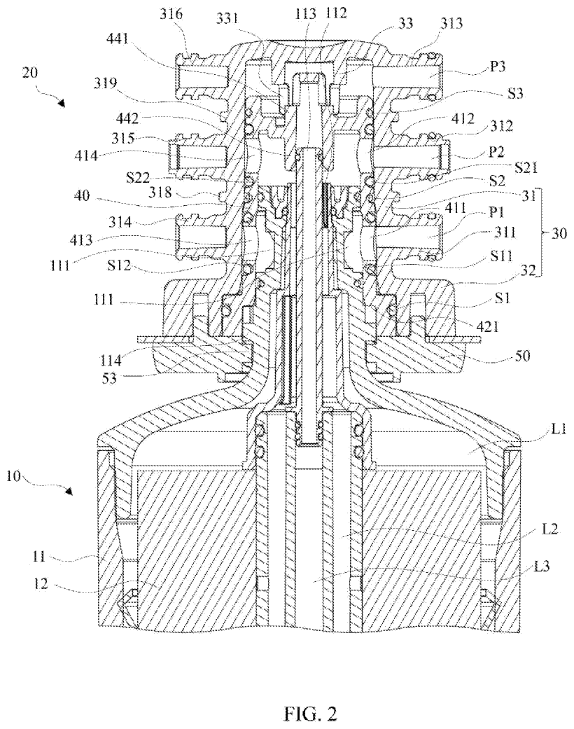

FIG. 1 shows a cross-sectional view of a filter 1 according to a first embodiment of the present disclosure, and FIG. 2 shows a partial enlarged view of FIG. 1.

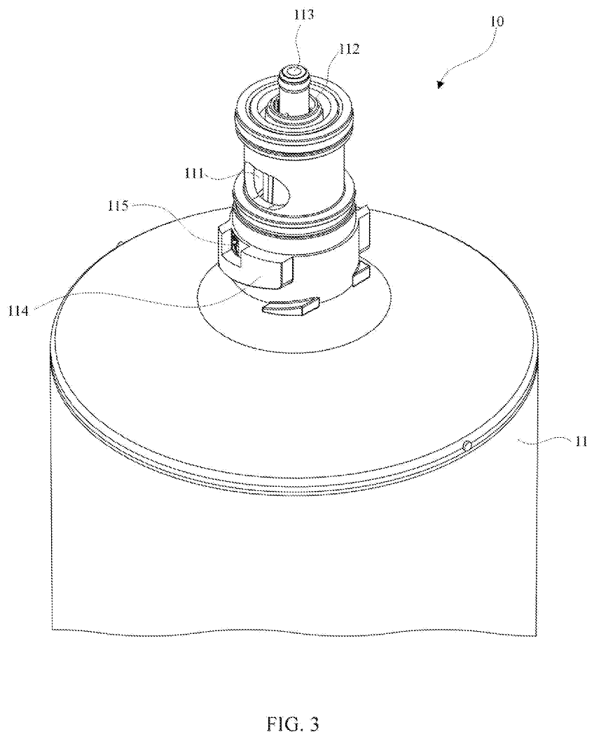

As shown in FIG. 1 and FIG. 2, the filter 1 includes a filter cartridge 10 and a filter head 20 mounted together. The filter 1 is configured to perform treatment on raw water (for example, municipal tap water) and provide two water outlets. The filter 1 includes a raw water port P1, a first water outlet port P2 and a second water outlet port P3 provided on the filter head 20. The raw water port P1 can be connected to a raw water pipeline (for example, a municipal tap water pipeline). FIG. 3 shows a partial perspective view of the filter cartridge 10. As shown in FIG. 1 to FIG. 3, the filter cartridge 10 has a housing 11 and a filtration medium 12 accommodated in the housing 11. The filter cartridge 10 is provided with a fluid inlet and a fluid outlet. The filter cartridge 10 may be provided with one fluid inlet or a plurality of fluid inlets spaced apart from each other. In this example, the filter cartridge 10 is provided with two fluid inlets 111 spaced apart from each other, and is provided with a first fluid outlet 112 and a second fluid outlet 113. When the filter cartridge 10 and the filter head 20 are mounted in place, the fluid inlet 111 of the filter cartridge 10 is in fluid communication with the raw water port P1 of the filter 1, and the first fluid outlet 112 and the second fluid outlet 113 of the filter cartridge 10 are respectively in fluid communication with the first water outlet port P2 and the second water outlet port P3 of the filter 1. The filter cartridge 10 is further provided with a mounting portion 114 and a retaining recess 115 (only shown in FIG. 3) provided on the mounting portion 114. The mounting portion 114 is provided on a housing top cover of the housing 11. An upper surface of the mounting portion 114 is a flat surface, and a lower surface of the mounting portion 114 is a helical surface. When the filter cartridge 10 is mounted to the filter head 20, the lower surface of the mounting portion 114 and the retaining recess 115 engage with corresponding portions of the filter head 20, as will be described hereinafter.

As shown in FIG. 1 and FIG. 2, raw water enters the filter 1 by means of the raw water port P1, and enters a raw water channel L1 in the filter cartridge 10 by means of the fluid inlet 111. The raw water entering the raw water channel L1 is treated by the filtration medium 12 of the filter cartridge 10 into a first outflow fluid and a second outflow fluid. The first outflow fluid flows into a first outflow channel L2, flows out of the filter cartridge 10 by means of the first fluid outlet 112, and can flow out of the filter 1 from the first water outlet port P2 for use or further treatment. The second outflow fluid flows into a second outflow channel L3, flows out of the filter cartridge 10 by means of the second fluid outlet 113, and can flow out of the filter 1 from the second water outlet port P3 for use or further treatment.

In the example shown in the figure, the filter cartridge 10 is a reverse osmosis membrane filter cartridge; the filtration medium 12 includes a reverse osmosis membrane; the first outflow fluid is pure water; the second outflow fluid is concentrated water. However, the present disclosure is not limited thereto. In another example according to the present disclosure, the filter cartridge 10 may be of another type, and therefore the first outflow fluid and the second outflow fluid may be other fluids acquired by means of treatment performed by the filter cartridge. For example, in an example, the filtration medium 12 of the filter cartridge 10 may include filtration media arranged in multiple stages, and the filter cartridge 10 is configured to filter the raw water to different levels and provide two product fluids filtered to different levels; therefore, the first outflow fluid and the second outflow fluid may respectively be a filtered first product fluid and a filtered second product fluid.

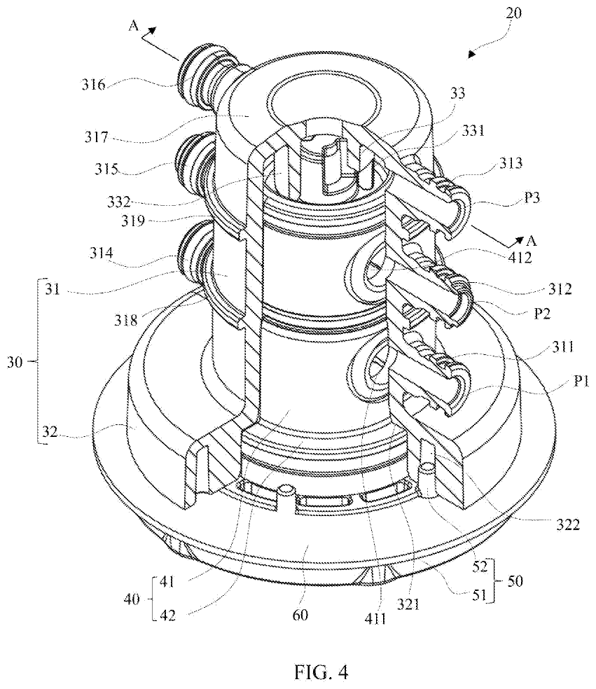

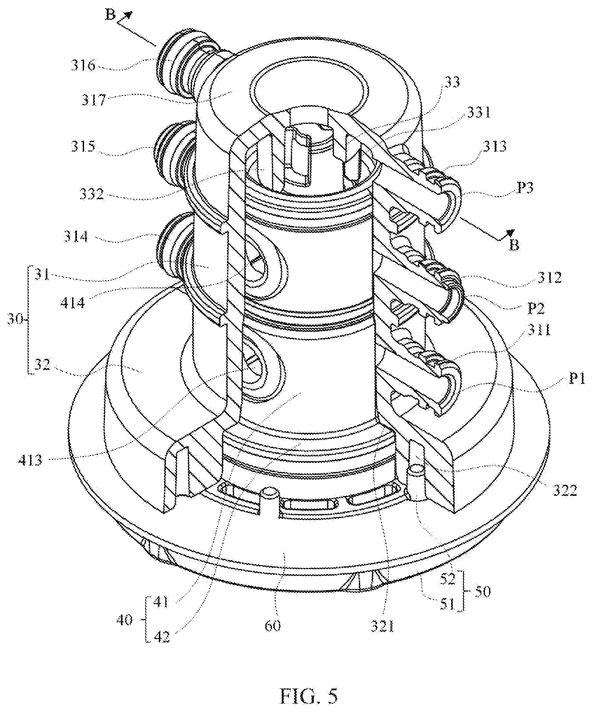

FIG. 4 and FIG. 5 respectively show partial cutaway perspective views of the filter head 20 in different mounting states. The filter head 20 includes a filter head housing 30, a valve 40 mounted in the filter head housing 30 and a filter head base 50.

The filter head housing 30 includes a cylindrical housing body 31 having a bottom and a housing flange 32. A circumferential wall of the housing body 31 is provided with a plurality of tubular portions. In this example, the circumferential wall of the housing body 31 is provided with a first group of tubular portions, a second group of tubular portions and a third group of tubular portions spaced apart from each other in an axial direction of the housing body 31. The first group of tubular portions includes a first tubular portion 311 and a fourth tubular portion 314 substantially at the same axial height. The second group of tubular portions includes a second tubular portion 312 and a fifth tubular portion 315 substantially at the same axial height. The third group of tubular portions includes a third tubular portion 313 and a sixth tubular portion 316 substantially at the same axial height. The first tubular portion 311, the second tubular portion 312 and the third tubular portion 313 are aligned with each other in the axial direction of the housing body 31, and extend radially outwards from the housing body 31. The fourth tubular portion 314, the fifth tubular portion 315 and the sixth tubular portion 316 are aligned with each other in the axial direction of the housing body 31, and extend radially outwards from the housing body 31. At least one tubular portion of the first group of tubular portions is in fluid communication with an inner cavity of the housing body 31 to form the raw water port P1 of the filter 1. At least one tubular portion of the second group of tubular portions is in fluid communication with the inner cavity of the housing body 31 to form the first water outlet port P2 of the filter 1. At least one tubular portion of the third group of tubular portions is in fluid communication with the inner cavity of the housing body 31 to form the second water outlet port P3 of the filter 1. In this example shown in FIG. 4 and FIG. 5, the first tubular portion 311 forms the raw water port P1 of the filter 1; the second tubular portion 312 forms the first water outlet port P2 of the filter 1; the third tubular portion 313 forms the second water outlet port P3 of the filter 1.

The housing flange 32 extends radially outwards from an open end (a lower end in FIG. 4 and FIG. 5) of the housing body 31, and extends axially. An inner surface of a circumferential wall of the housing flange 32 is located on a radial outer side of an inner surface of the circumferential wall of the housing body 31, so that in an inner cavity of the filter head housing 30, a housing step portion 321 is formed between the inner surface of the circumferential wall of the housing body 31 and the inner surface of the circumferential wall of the housing flange 32. An axial end surface of the housing flange 32 is provided with a plurality of mounting holes 322 spaced apart from each other circumferentially. The mounting hole 322 is configured to engage with the filter head base 50 to be described below.

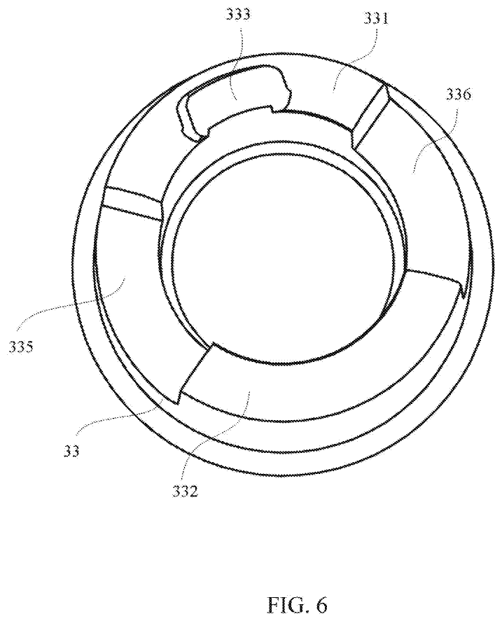

The filter head housing 30 is further provided with an annular wall 33 axially extending from a top wall 317 of the housing body 31 into the inner cavity of the housing body 31. FIG. 6 shows a partial perspective view of the filter head housing 30, and shows the annular wall 33. An axial end portion of the annular wall 33 is provided with one or a plurality of notches. In the example shown in FIG. 6, the axial end portion of the annular wall 33 is provided with a first notch 335 and a second notch 336 spaced apart circumferentially and arranged symmetrically, so that a first curved wall 331 and a second curved wall 332 extending axially are formed on the axial end portion of the annular wall 33. The first curved wall 331 and the second curved wall 332 are spaced apart from each other circumferentially and arranged symmetrically. An axial end portion of one of the first curved wall 331 and the second curved wall 332 is provided with a position-limiting protrusion 333. In the example shown in the figure, the position-limiting protrusion 333 is provided on the axial end portion of the first curved wall 331. The first curved wall 331 and the second curved wall 332 engage with the valve 40 to be described below.

Preferably, an outer circumferential wall of the housing body 31 of the filter head housing 30 is provided with a rib portion circumferentially extending thereon to increase the strength of the housing body 31. In the embodiment shown in FIG. 4 and FIG. 5, the rib portion on the outer circumferential wall of the housing body 31 of the filter head housing 30 comprises a first annular rib 318 and a second annular rib 319. The first annular rib 318 is provided between the first group of tubular portions and the second group of tubular portions in the axial direction of the housing body 31, and extends circumferentially on the outer circumferential wall of the housing body 31. The second annular rib 319 is generally parallel to the first annular rib 318 and provided between the second group of tubular portions and the third group of tubular portions in the axial direction of the housing body 31, and extends circumferentially on the outer circumferential wall of the housing body 31.

In an embodiment, all portions of the filter head housing 30 are integrally formed by means of injection molding. In the process of injection molding of each portion of the filter head housing 30, for example, when forming each tubular portion of the filter head housing 30, molten injection molding fluids flow separately around the internal mold and then converge between the adjacent tubular portions. The strengths of formed portions of the filter head housing 30 may be different, and the strength at the region between the adjacent tubular portions where the molten injection molding fluids converge may be weak. Integrally forming the first annular rib 318 and the second annular rib 319 by means of injection molding can significantly increase the strength of the region between the tubular portions, thus improving the overall strength of the filter head housing 30. The thicknesses of the first annular rib 318 and the second annular rib 319 (the axial dimension of the filter head housing 30) are not particularly limited as long as the connection between each tubular portion and other connectors is not affected. In the embodiment as shown, one first annular rib 318 is provided between the first group of tubular portions and the second group of tubular portions, and one second annular rib 319 is provided between the second group of tubular portions and the third tubular portions. However, the present disclosure is not limited thereto. In other example according to the present disclosure, as along as the connection between each tubular portion and other connectors is not affected, a plurality of first annular ribs that are spaced apart from each other in the axial direction of the housing body 31 can be provided between the first group of tubular portions and the second group of tubular portions, and/or a plurality of second annular ribs that are spaced apart from each other in the axial direction of the housing body 31 can be provided between the second group of tubular portions and the third group of tubular portions.

Additionally, in other embodiment according to the present disclosure, in addition to the first annular rib 318 and the second annular rib 319 provided between each group of tubular portions, the rib on the outer circumferential wall of the housing body 31 of the filter head housing 30 can further comprise a curved rib that is provided between the tubular portions of the same group and extends circumferentially on the outer circumferential wall of the housing body 31. For example, in one embodiment, on the outer circumferential wall of the housing body 31 of the filter head housing 30, a curved rib extending circumferentially between the tubular portions of the first group (the first tubular portion 311 and the fourth tubular portion 314) on the outer circumferential wall of the housing body 31 can be provided, and two ends of the curved rib respectively extend to the adjacent tubular portions (the first tubular portion 311 and the fourth tubular portion 314) of the first group of tubular portions; a curved rib extending circumferentially between the tubular portions of the second group (the second tubular portion 312 and the fifth tubular portion 315) on the outer circumferential wall of the housing body 31 can be provided, and two ends of the curved rib respectively extend to the adjacent tubular portions (the second tubular portion 312 and the fifth tubular portion 315) of the second group of tubular portions; and a curved rib extending circumferentially between the tubular portions of the third group (the third tubular portion 313 and the sixth tubular portion 316) on the outer circumferential wall of the housing body 31 can be provided, and two ends of the curved rib respectively extend to the adjacent tubular portions (the third tubular portion 313 and the sixth tubular portion 316) of the third group of tubular portions.

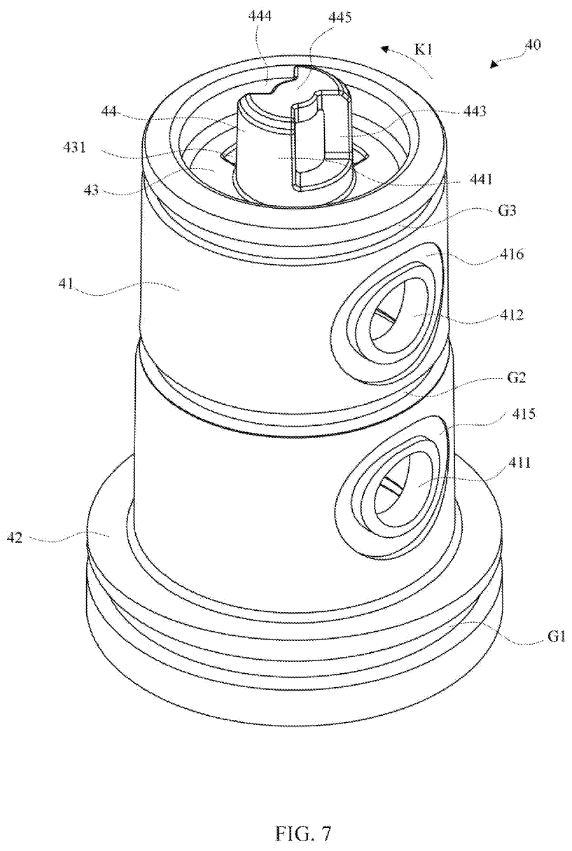

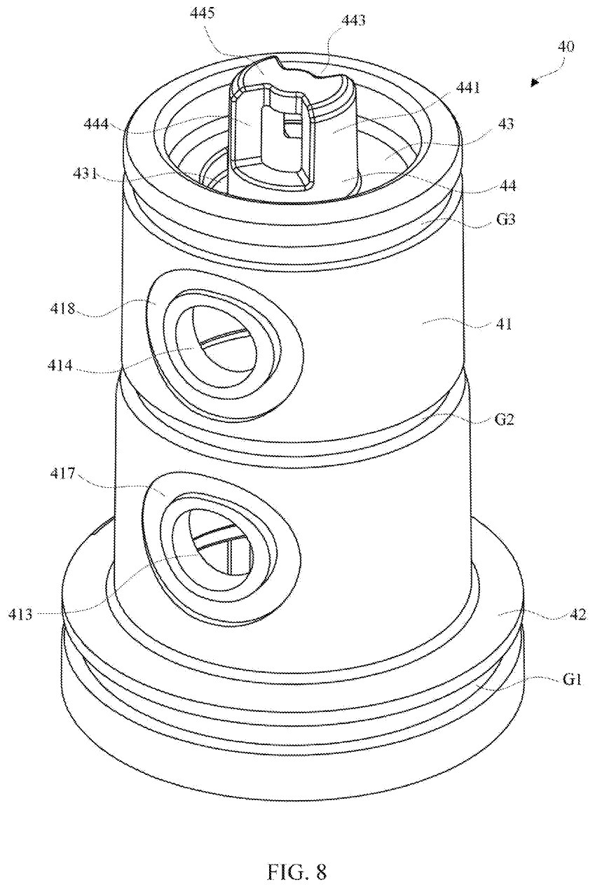

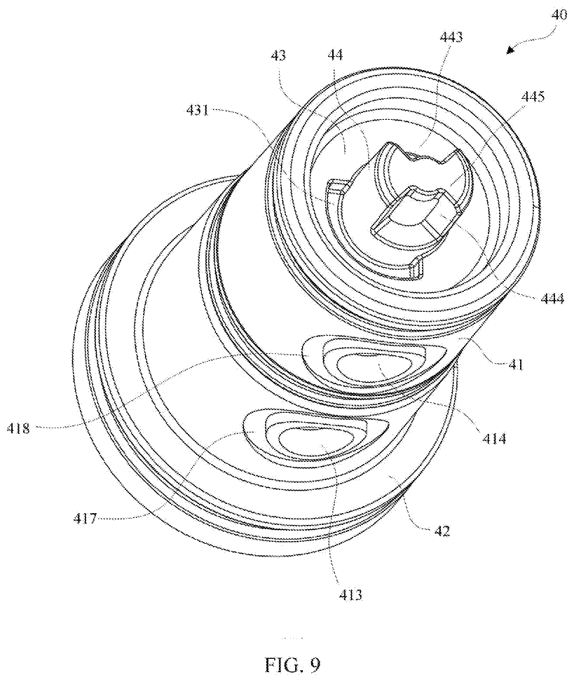

The valve 40 is mounted in the filter head housing 30, and can rotate relative to the filter head housing 30 to an open position shown in FIG. 4 or a closed position shown in FIG. 5. FIG. 7 to FIG. 9 show perspective views of the valve 40 taken from different angles. The position of the valve 40 shown in FIG. 7 corresponds to the position of the valve 40 in FIG. 4. FIG. 8 shows a perspective view of the valve 40 shown in FIG. 7 taken by rotating the valve 40 by an angle (for example, by rotating the valve 40 by 90 degrees) in a direction of an arrow K1, and the position of the valve 40 shown in FIG. 8 corresponds to the position of the valve 40 shown in FIG. 5. FIG. 9 shows a top structure of the valve 40 from another angle.

As shown in FIG. 7 to FIG. 9, the valve 40 includes a valve body 41 and a valve flange 42. A circumferential wall of the valve body 41 is provided with a first group of through holes and a second group of through holes spaced apart from each other in an axial direction of the valve body 41. One or both of the first group of through holes and the second group of through holes may be provided with one or a plurality of through holes. Preferably, the number of through holes of the first group of through holes and the number of through holes of the second group of through holes of the valve body 41 are respectively the same as the number of tubular portions of the first group of tubular portions and the number of tubular portions of the second group of tubular portions of the housing body 31. In the example shown in the figure, the first group of through holes and the second group of through holes each include two through holes. The first group of through holes includes a first through hole 411 and a third through hole 413 spaced apart from each other in a circumferential direction of the valve body 41, and the first through hole 411 and the third through hole 413 are located at substantially the same axial height. The second group of through holes includes a second through hole 412 and a fourth through hole 414 spaced apart from each other in the circumferential direction of the valve body 41, and the second through hole 412 and the fourth through hole 414 are located at substantially the same axial height. An outer surface of the circumferential wall of the valve body 41 is further provided with an annular groove surrounding each through hole so as to mount a seal. Specifically, the outer surface of the circumferential wall of the valve body 41 is provided with a first annular groove 415 surrounding the first through hole 411, a second annular groove 416 surrounding the second through hole 412, a third annular groove 417 surrounding the third through hole 413, and a fourth annular groove 418 surrounding the fourth through hole 414.

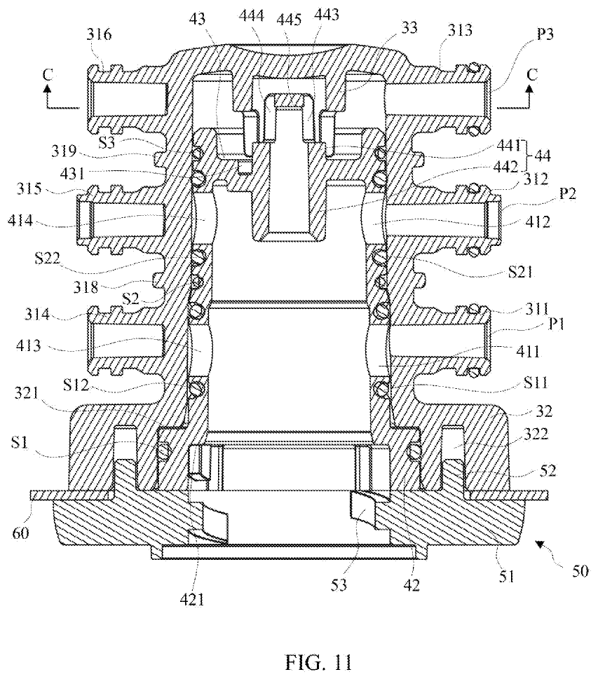

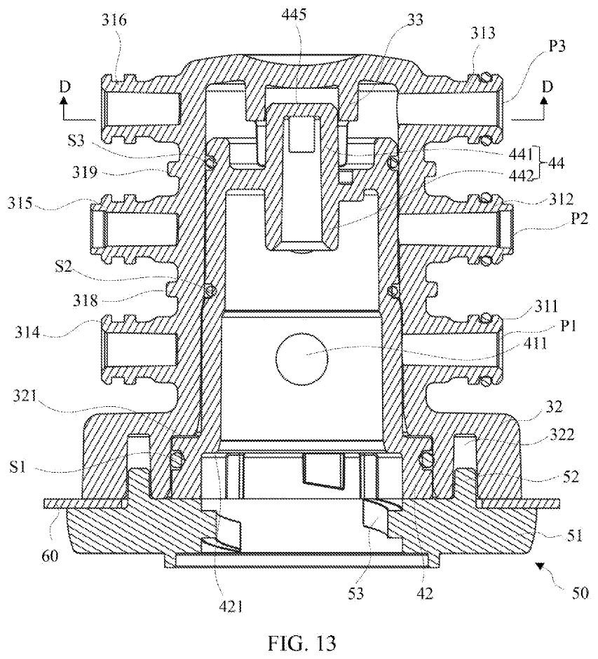

The valve body 41 is provided with a transverse wall 43 located on an axial end portion (an axial upper end portion in FIG. 7 and FIG. 8) of the valve body 41. An inner cylindrical portion 44 is formed on a central portion of the transverse wall 43. The inner cylindrical portion 44 axially extends through the transverse wall 43, extends on two axial sides of the transverse wall 43, and includes a first inner cylinder portion 441 located axially above the transverse wall 43 and a second inner cylinder portion 442 (not visible in FIG. 7-FIG. 9, but shown in FIG. 2, FIG. 11, and FIG. 13) located axially below the transverse wall 43. The first inner cylinder portion 441 is provided with an opening portion or a plurality of opening portions spaced apart from each other circumferentially. In the example shown in the figure, the first inner cylinder portion 441 is provided with a first opening portion 443 and a second opening portion 444 arranged circumferentially and symmetrically. In this example, the first inner cylinder portion 441 is a cylindrical portion having a bottom; an upper end portion of the first inner cylinder portion 441 is provided with an end wall 445; the first opening portion 443 and the second opening portion 444 may extend to the end wall 445 of the first inner cylinder portion 441. Alternatively, the first inner cylinder portion 441 may also be a cylindrical portion having no bottom, that is, no end wall 445 is provided. The first inner cylinder portion 441 has a size designed to match the size of the annular wall 33 of the filter head housing 30, so that when the valve 40 is mounted in the housing body 31, the annular wall 33 of the filter head housing 30 is sleeved on the first inner cylinder portion 441 of the valve 40, and the valve 40 can rotate relative to the filter head housing 30 so as to selectively cause the first opening portion 443 and the second opening portion 444 to be respectively completely blocked by the first curved wall 331 and the second curved wall 332 of the filter head housing 30 or to be respectively aligned with the first notch 335 and the second notch 336 of the filter head housing 30. The second inner cylinder portion 442 has a size designed to match the second fluid outlet 113 of the filter cartridge 10. Referring to FIG. 1 and FIG. 2, the second fluid outlet 113 of the filter cartridge 10 is sealedly mounted in the second inner cylinder portion 442 of the valve 40. An upper surface of the transverse wall 43 is further provided with a position-limiting recess 431, as best shown in FIG. 9. The position-limiting recess 431 is a curved recess having an arc angle of about 90 degrees, and is located on a radial outer side of the inner cylindrical portion 44. The position-limiting recess 431 is configured to accommodate the position-limiting protrusion 333 on the first curved wall 331 of the filter head housing 30. When the valve 40 rotates relative to the filter head housing 30, the position-limiting protrusion 333 of the filter head housing 30 moves within the position-limiting recess 431 of the valve 40. In order to limit a rotation range of the valve 40 relative to the filter head housing 30, one of the valve 40 and the filter head housing 30 is provided with a first position-limiting portion, and the other one of the valve 40 and the filter head housing 30 is provided with a second position-limiting portion. The first position-limiting portion and the second position-limiting portion jointly define the rotation range of the valve 40 relative to the filter head housing 30. In this example, the first position-limiting portion is the position-limiting protrusion 333 provided on the first curved wall 331, and the second position-limiting portion is the position-limiting recess 431 provided on the transverse wall 43 of the valve body 41.

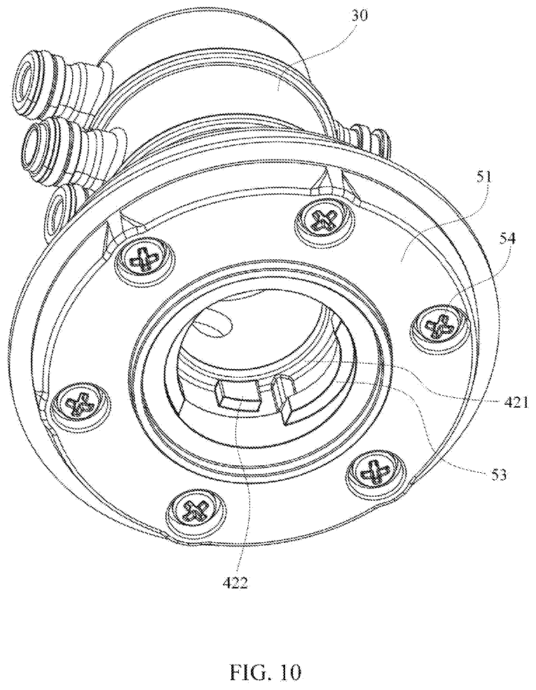

The valve flange 42 extends radially outwards from the other axial end portion (an axial lower end portion in FIG. 7 and FIG. 8) of the valve body 41, and extends axially. An inner surface of a circumferential wall of the valve flange 42 is located on a radial outer side of an inner surface of the circumferential wall of the valve body 41, so that in an inner cavity of the valve 40, a valve step portion 421 (shown in FIG. 2, FIG. 11 and FIG. 13) is formed between an inner surface of the circumferential wall of the valve body 41 and the inner surface of the circumferential wall of the valve flange 42. The valve flange 42 engages with the filter head housing 30 and the filter head base 50. The inner surface of the circumferential wall of the valve flange 42 is provided with a protruding portion 422, as best shown in FIG. 10. When the filter cartridge 10 is mounted to the filter head 20, the protruding portion 422 is accommodated in the retaining recess 115 of the filter cartridge 10 (the protruding portion 422 and the retaining recess 115 are respectively shown in FIG. 10 and FIG. 3), and engages with the retaining recess 115, so that when the filter cartridge 10 is rotated, the retaining recess 115 and the protruding portion 422 engaging with each other can drive the valve 40 to rotate therewith.

The valve 40 is further provided with a first circumferential groove G1, a second circumferential groove G2 and a third circumferential groove G3. The first circumferential groove G1 is provided on an outer surface of the circumferential wall of the valve flange 42, and is used to mount a first seal S1. The second circumferential groove G2 is provided on the outer surface of the circumferential wall of the valve body 41, is located axially between the first group of through holes (the first through hole 411 and the third through hole 413) and the second group of through holes (the second through hole 412 and the fourth through hole 414), and is used to mount a second seal S2. The third circumferential groove G3 is provided on the outer surface of the circumferential wall of the valve body 41, is located axially above the second group of through holes (the second through hole 412 and the fourth through hole 414), and is used to mount a third seal S3. When the valve 40 is mounted in the filter head housing 30, the third circumferential groove G3 and the third seal S3 are located axially below the third tubular portion 313 of the filter head housing 30 to isolate the third tubular portion 313 and the second tubular portion 312 from each other so that the third tubular portion 313 and the second tubular portion 312 are not in communication with each other.

The filter head base 50 is mounted to the filter head housing 30, and the filter head base 50 and the filter head housing 30 jointly define an axial position of the valve 40. The filter head base 50 includes a base body portion 51 and a plurality of position-limiting protrusions 52. The plurality of position-limiting protrusions 52 axially extends from a side surface (an upper surface in FIG. 4 and FIG. 5) of the base body portion 51, and are spaced apart from one another circumferentially. As shown in FIG. 10, the filter head base 50 is fixedly mounted to the filter head housing 30 by means of a plurality of fixing screws 54 such that the position-limiting protrusions 52 are mounted to the mounting holes 322 of the housing flange 32 of the filter head housing 30, and an upper surface of the base body portion 51 located on a radial inner side of the position-limiting protrusion 52 abuts an axial end portion surface of the housing flange 32 of the filter head housing 30 to limit the valve flange 42 of the valve 40 between the base body portion 51 and the housing step portion 321 of the filter head housing 30 so as to maintain the axial position of the valve 40, such that the valve 40 can rotate relative to the filter head housing 30 and the filter head base 50 but cannot move axially relative to the filter head housing 30 and the filter head base 50. An inner wall surface of the base body portion 51 of the filter head base 50 is provided with a plurality of retaining portions 53 spaced apart from each other, as shown in FIG. 10. In this example, the base body portion 51 is provided with two retaining portions 53 spaced apart from each other. An upper surface of the retaining portion 53 is configured to be a helical surface corresponding to a lower surface of the mounting portion 114 of the filter cartridge 10 (the mounting portion 114 is shown in FIG. 3). When the filter cartridge 10 and the filter head 20 are mounted in place, the mounting portion 114 of the filter cartridge 10 is supported on the corresponding retaining portion 53, and the lower surface of the mounting portion 114 engages with the upper surface of the retaining portion 53. As shown in FIG. 4 and FIG. 5, a spacer 60 is further sandwiched between the filter head base 50 and the filter head housing 30 to ensure stable mounting between the filter head base 50 and the filter head housing 30. The spacer 60 may be a metal spacer or other suitable spacers.

FIG. 11 shows a cross-sectional view taken along a section line A-A in FIG. 4, and shows the filter head housing 30, the valve 40 and the filter head base 50 mounted together.

The valve 40 is sealedly mounted in the inner cavity of the filter head housing 30 by means of the first seal S1, the second seal S2 and the third seal S3, such that the first through hole 411 and the third through hole 413 of the valve 40 are respectively located at axial heights substantially corresponding to the first tubular portion 311 and the fourth tubular portion 314 of the filter head housing 30, and the second through hole 412 and the fourth through hole 414 of the valve 40 are respectively located at axial heights substantially corresponding to the second tubular portion 312 and the fifth tubular portion 315 of the filter head housing 30. The first opening portion 443 and the second opening portion 444 of the first inner cylinder portion 441 of the valve 40 are located above axial ends of the first curved wall 331 and the second curved wall 332 of the filter head housing 30, such that the first opening portion 443 and the second opening portion 444 can be selectively completely blocked by the first curved wall 331 and the second curved wall 332 to interrupt fluid connection between the first opening portion 443 and the second opening portion 444 and the third tubular portions 313 of the filter head housing 30 or can be selectively caused to be aligned with the first notch 335 and the second notch 336 of the filter head housing 30 to establish fluid communication between the first opening portion 443 and the second opening portion 444 and the third tubular portion 313 of the filter head housing 30 by means of the first notch 335 and the second notch 336. The first seal S1 is mounted in the first circumferential groove G1 of the valve 40, and contacts an inner surface of a circumferential wall of the filter head housing 30 so as to prevent the raw water flowing in by means of the first tubular portion 311 from leaking from a position between the valve 40 and the filter head housing 30. The second seal S2 is mounted in the second circumferential groove G2 of the valve 40, and contacts the inner surface of the circumferential wall of the filter head housing 30 so as to prevent the first outflow fluid flowing out from the second through hole 412 and the fourth through hole 414 of the valve 40 from mixing with the raw water flowing in from the first tubular portion 311. The third seal S3 is mounted in the third circumferential groove G3 of the valve 40, and contacts the inner surface of the circumferential wall of the filter head housing 30 so as to prevent the second outflow fluid flowing out from the first opening portion 443 and the second opening portion 444 of the valve 40 from mixing with the first outflow fluid flowing out from the second through hole 412 and the fourth through hole 414 of the valve 40.

Each through hole surrounding the valve 40 is further provided with a corresponding seal. Specifically, a seal S11 is mounted in the first annular groove 415 surrounding the first through hole 411; a seal S21 is mounted in the second annular groove 416 surrounding the second through hole 412; a seal S12 is mounted in the third annular groove 417 surrounding the third through hole 413; and a seal S22 is mounted in the fourth annular groove 418 surrounding the fourth through hole 414. The seals S11 and S12 contact the inner surface of the circumferential wall of the filter head housing 30 to prevent the raw water flowing through the first through hole 411 and the third through hole 413 from leaking to outer regions of the seals S11 and S12. The seals S21 and S22 contact the inner surface of the circumferential wall of the filter head housing 30 to prevent the first outflow fluid flowing through the second through hole 412 and the fourth through hole 414 from leaking to outer regions of the seals S21 and S22.

FIG. 11 shows that each through hole of the valve 40 is in an open position in which the through hole is in communication with a corresponding tubular portion of the filter head housing 30. As shown in FIG. 11, when the valve 40 is in the open position, the first through hole 411 of the valve 40 is aligned with and in communication with an opening of the first tubular portion 311 of the filter head housing 30, the second through hole 412 of the valve 40 is aligned with and in communication with an opening of the second tubular portion 312 of the filter head housing 30, and the first opening portion 443 and the second opening portion 444 of the first inner cylinder portion 441 of the valve 40 are not completely blocked by the first curved wall 331 and the second curved wall 332 of the filter head housing 30, and therefore, the first opening portion 443 and the second opening portion 444 are in fluid communication with the third tubular portion 313 of the filter head housing 30.

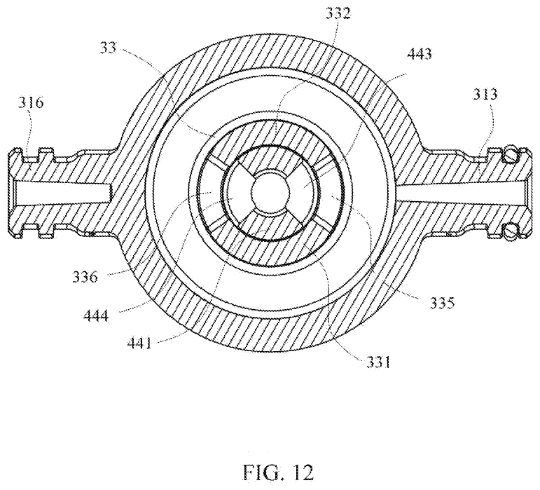

FIG. 12 shows a cross-sectional view taken along a section line C-C in FIG. 11, and shows relative positions between the first curved wall 331 and the second curved wall 332 of the annular wall 33 of the filter head housing 30 and the first opening portion 443 and the second opening portion 444 of the valve 40. As shown in FIG. 12, the valve 40 is disposed such that the first opening portion 443 is aligned with the first notch 335 between the first curved wall 331 and the second curved wall 332 of the filter head housing 30 and the second opening portion 444 is aligned with the second notch 336 between the first curved wall 331 and the second curved wall 332 of the filter head housing 30. The first opening portion 443 and the second opening portion 444 are not completely blocked by the first curved wall 331 and the second curved wall 332, and the first opening portion 443 and the second opening portion 444 are in communication with a cavity of a radial outer side of the annular wall 33 of the filter head housing 30 and therefore are in communication with an opening of the third tubular portion 313, such that an inner cavity of the inner cylindrical portion 44 of the valve 40 is in fluid communication with the third tubular portion 313, and therefore the second fluid outlet 113 of the filter cartridge 10 located in the inner cylindrical portion 44 is caused to be in communication with the third tubular portion 313, that is, the second fluid outlet 113 of the filter cartridge 10 is in fluid communication with the second water outlet port P3 of the filter 1 (as shown in FIG. 2).

FIG. 13 shows a cross-sectional view taken along a section line B-B in FIG. 5, and shows that each through hole of the valve 40 is in a closed position in which the through hole are not in communication with any tubular portion of the filter head housing 30.

As shown in FIG. 13, when the valve 40 is in the closed position, the first through hole 411 of the valve 40 faces the inner surface of the circumferential wall of the filter head housing 30 and is not aligned with the first tubular portion 311, and the seal S11 (not shown in FIG. 13) provided in the first annular groove 415 surrounding the first through hole 411 contacts the inner surface of the circumferential wall of the filter head housing 30, such that the first through hole 411 is not in fluid communication with the first tubular portion 311. Similarly, the third through hole 413 is also not in fluid communication with the first tubular portion 311. The first seal S1 is provided between the valve 40 and the filter head housing 30. Therefore, even if the raw water pipeline connected to the raw water port P1 is not closed, the raw water flowing into the first tubular portion 311 by means of the raw water port P1 does not flow into the valve 40 or leak from a position between the valve 40 and the filter head housing 30.

Similarly, both the second through hole 412 and the fourth through hole 414 (not shown in FIG. 13) face the inner surface of the circumferential wall of the filter head housing 30. Both of the seal S21 provided in the second circular groove 416 surrounding the second through hole 412 and the seal S22 provided in the fourth circular groove 418 surrounding the fourth through hole 414 contact the inner surface of the circumferential wall of the filter head housing 30. Neither the second through hole 412 nor the fourth through hole 414 is in fluid communication with the second tubular portion 312. Therefore, even if the first water outlet pipeline connected to the first water outlet port P2 is not closed, the first outflow fluid in the second tubular portion 312 does not flow back into the valve 40.

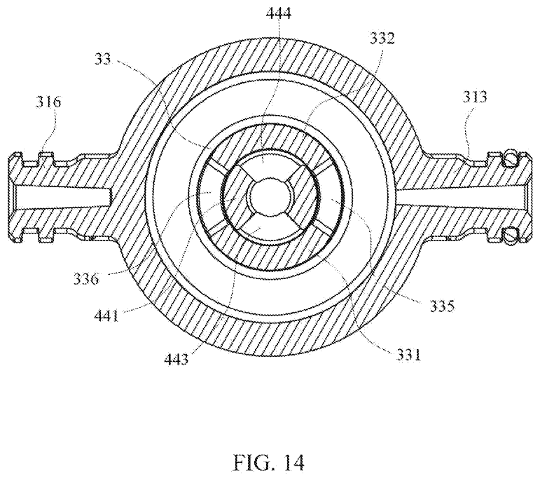

FIG. 14 shows a cross-sectional view taken along a section line D-D in FIG. 13. As shown in FIG. 14, when the valve 40 is in the closed position, the first opening portion 443 and the second opening portion 444 of the first inner cylinder portion 441 are respectively completely blocked by the first curved wall 331 and the second curved wall 332 of the filter head housing 30; the first curved wall 331 and the second curved wall 332 sealedly engage with the first inner cylinder portion 441; neither the first opening portion 443 nor the second opening portion 444 is in fluid communication with the third tubular portion 313; and therefore the inner cavity of the inner cylindrical portion 44 is not in fluid communication with the third tubular portion 313. Therefore, even if the second water outlet pipeline connected to the second water outlet port P3 is not closed, the second outflow fluid in the third tubular portion 313 does not flow back into the valve 40.

Since the first seal S1, the second seal S2 and the third seal S3 are provided between the valve 40 and the filter head housing 30, the raw water flowing through the first tubular portion 311, the first outflow fluid flowing through the second tubular portion 312 and the second outflow fluid flowing through the third tubular portion 313 are prevented from mixing with one another.

In the example shown in the figure, the first inner cylinder portion 441 of the valve 40 is provided with a first opening portion 443 and a second opening portion 444 arranged circumferentially and symmetrically, and the annular wall 33 of the filter head housing 30 is provided with a first notch 335 and a second notch 336 spaced apart from each other. However, the present disclosure is not limited thereto. In another example according to the present disclosure, the first inner cylinder portion 441 of the valve 40 may be provided with only one opening portion, for example, the first opening portion 443, and correspondingly, the axial end portion of the annular wall 33 of the filter head housing may be provided with only one notch, for example, the first notch 335.

The main structures of the filter head 20 and the filter 1 having the filter head 20 are described above. With reference to the accompanying drawings, the mounting and removal of the filter cartridge 10 to and from the filter head 20 of the filter 1 are described below.

Referring to FIG. 3 and FIG. 10, when the filter cartridge 10 and the filter head 20 are mounted in place, the mounting portion 114 of the filter cartridge 10 is limited between the retaining portion 53 of the filter head base 50 and the valve step portion 421 of the valve 40; the mounting portion 114 is supported on the retaining portion 53 of the filter head base 50 of the filter head 20; and the retaining recess 115 of the filter cartridge 10 and the protruding portion 422 of the filter head 20 engage with each other. Referring to FIG. 1 and FIG. 2, when the filter cartridge 10 and the filter head 20 are mounted in place, the two fluid inlets 111 of the filter cartridge 10 are respectively aligned with and in communication with the first through hole 411 and the third through hole 413 of the valve 40 of the filter head 20; the first fluid outlet 112 of the filter cartridge 10 is in communication with the second through hole 412 and the fourth through hole 414 of the valve 40; the second fluid outlet 113 of the filter cartridge 10 is sealedly mounted in the second inner cylinder portion 442 of the inner cylindrical portion 44 of the valve 40; and the valve 40 of the filter head 20 is in the open position shown in FIG. 11 relative to the filter head housing 30. Therefore, the raw water port P1 is in fluid communication with the fluid inlet 111 of the filter cartridge 10, the first water outlet port P2 is in fluid communication with the first fluid outlet 112 of the filter cartridge 10, and the second water outlet port P3 is in fluid communication with the second fluid outlet 113 of the filter cartridge 10. The raw water flows into the filter 1 by means of the raw water port P1, flows into the raw water channel L1 of the filter cartridge 10 by means of the first through hole 411 of the valve 40 and the fluid inlet 111 of the filter cartridge 10, and is treated by the filtration medium 12 of the filter cartridge 10 into the first outflow fluid and the second outflow fluid. The first outflow fluid flows into the first outflow channel L2 of the filter cartridge 10, flows out of the filter cartridge from the first fluid outlet 112, flows through the second through hole 412 of the valve 40, and flows out of the filter 1 from the first water outlet port P2. The second outflow fluid flows into the second outflow channel L3 of the filter cartridge 10, flows out of the filter cartridge 10 from the second fluid outlet 113, flows into the inner cylindrical portion 44 of the valve 40, flows out of the valve 40 by means of the first opening portion 443 and the second opening portion 444 (see FIG. 11), flows into the third tubular portion 313, and flows out of the filter 1 by means of the second water outlet port P3.

When the filter cartridge 10 of the filter 1 needs to be replaced, an operator rotates the filter cartridge 10 in a removal direction. Since the retaining recess 115 of the filter cartridge 10 and the protruding portion 422 on the valve 40 of the filter head 20 engage with each other, rotation of the filter cartridge 10 drives the valve 40 to rotate relative to the filter cartridge housing 30. When the filter cartridge 10 and the valve 40 are rotated together such that the valve 40 is in the closed position shown in FIG. 13, all of the fluid communication between the raw water port P1 and the valve 40, the fluid communication between the first water outlet port P2 and the valve 40 and the fluid communication between the second water outlet port P3 and the valve 40 are interrupted. Even if pipelines connected to these ports are not closed, the fluid in each pipeline does not flow into the valve 40. In this case, the mounting portion 114 of the filter cartridge 10 is no longer supported on the retaining portion 53 of the filter head base 50. Therefore, the filter cartridge 10 can be pulled downwards to disengage the retaining recess 115 of the filter cartridge 10 with the protruding portion 422 of the valve 40 so as to remove the filter cartridge 10 from the filter head 20.

When mounting a new filter cartridge 10 to the filter head 20, the retaining recess 115 of the new filter cartridge 10 is caused to be aligned with the protruding portion 422 of the valve 40, and the filter cartridge 10 is pushed upwards, so that the protruding portion 422 of the valve 40 engages with the retaining recess 115 of the filter cartridge 10. Then the filter cartridge 10 is rotated in a mounting direction opposite to the removal direction, and the valve 40 of the filter head 20 is driven by the retaining recess 115 and the protruding portion 422 contacting each other to rotate together, so that the helical lower surface of the mounting portion 114 of the filter cartridge 10 helically rises along the helical upper surface of the retaining portion 53 of the filter head base 50. When the filter cartridge 10 and the valve 40 are rotated together so that the mounting portion 114 of the filter cartridge 10 is limited between the valve step portion 421 and the retaining portion 53 of the valve 40 and cannot be further rotated, the mounting portion 114 of the filter cartridge 10 is supported on the retaining portion 53 of the filter head base 50, and the valve 40 is in the open position shown in FIG. 11. In this case, as shown in FIG. 1 and FIG. 2, the new filter cartridge 10 and the filter head 20 are mounted in place.

The filter head 20 and the filter 1 having the filter head 20 according to the first embodiment of the present disclosure are described above. The mounting and removal of the filter cartridge 10 to and from the filter head 20 according to the first embodiment of the present disclosure are easy, do not require that the fluid pipeline connected to each port of the filter should be closed in advance, and can effectively prevent fluids from mixing with each other.

In the above preferred embodiment, one tubular portion of each of the first group of tubular portions, the second group of tubular portions and the third group of tubular portions of the filter head housing 30 is in fluid communication with the inner cavity of housing body 31 so as to form the raw water port P1, the first water outlet port P2 and the second water outlet port P3 aligned with one another axially, and the other tubular portions are not in fluid communication with the inner cavity of the housing body 31. However, the present disclosure is not limited thereto. In another modification example according to the present disclosure, any one or two tubular portions of each of the first group of tubular portions, the second group of tubular portions and the third group of tubular portions may be caused to be in fluid communication with the inner cavity of the housing body 31 according to a specific application of the filter 1. In the above preferred embodiment, each of the first group of tubular portions, the second group of tubular portions and the third group of tubular portions of the filter head housing 30 is provided with two tubular portions. However, the present disclosure is not limited thereto. In another example according to the present disclosure, one or more of the first group of tubular portions, the second group of tubular portions and the third group of tubular portions may be provided with fewer or more tubular portions, for example, one tubular portion or three tubular portions may be provided.

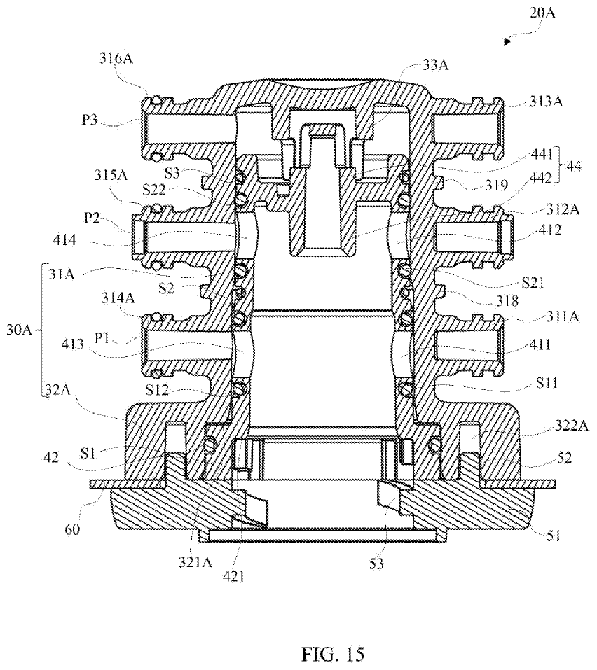

FIG. 15 shows a filter head 20A according to a first modification example of the present disclosure. The filter head 20A according to the first modification example of the present disclosure has substantially the same structure as the filter head 20 according to the first embodiment of the present disclosure, and the only difference therebetween lies in the structure of a filter head housing 30A of the filter head 20A. Therefore, in the accompanying drawings and the following, the same components are represented by the same reference numerals, and the corresponding descriptions are omitted. The following will mainly describe the differences between the two.

The filter head 20A includes a filter head housing 30A, a valve 40 and a filter head base 50. The valve 40 and the filter head base 50 of the filter head 20A are the same as the valve 40 and the filter head base 50 of the filter head 20 described above. The differences between the filter head housing 30A of the filter head 20A and the filter head housing 30 of the filter head 20 are only as follows: none of a first tubular portion 311A, a second tubular portion 312A and a third tubular portion 313A of the filter head housing 30A is in communication with an inner cavity of the filter head housing 30A, and all of a fourth tubular portion 314A, a fifth tubular portion 315A and a sixth tubular portion 316A are in communication with the inner cavity of the filter head housing 30A and therefore can respectively be in fluid communication with the fluid inlet, the first fluid outlet and the second fluid outlet of the filter cartridge mounted to the filter head 20A. The fourth tubular portion 314A forms the raw water port P1, the fifth tubular portion 315A forms the first water outlet port P2, and the sixth tubular portion 316A forms the second water outlet port P3.

The filter head 20A and a filter having the filter head 20A according to the first modification example of the present disclosure can achieve the same beneficial technical effect as the filter head 20 and the filter 1 according to the first embodiment of the present disclosure. In an example, the filter mounted with the filter head 20A can also be implemented by rotating the filter head 20 of the filter 1 shown in FIG. 1 by 180 degrees relative to the filter cartridge.

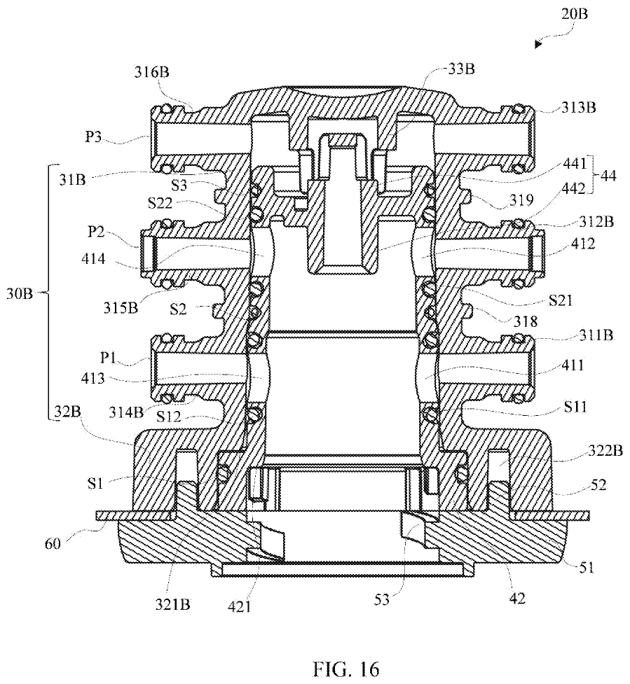

FIG. 16 shows a filter head 20B according to a second modification example of the present disclosure. The filter head 20B according to the second modification example of the present disclosure has substantially the same structure as the filter head 20 according to the first embodiment of the present disclosure, and the only difference lies in the structure of a filter head housing 30B of the filter head 20B.

The difference between the filter head housing 30B of the filter head 20B and the filter head housing 30 of the filter head 20 only lies in that all of tubular portions of the filter head housing 30B are in communication with an inner cavity of the filter head housing 30B. Therefore, both a first tubular portion 311B and a fourth tubular portion 314B of the filter head housing 30B can be in communication with the fluid inlet 111 of the filter cartridge mounted to the filter head 20B, both a second tubular portion 312B and a fifth tubular portion 315B of the filter head housing 30B can be in communication with the first fluid outlet 112 of the filter cartridge, and both a third tubular portion 313B and a sixth tubular portion 316B of the filter head housing 30B can be in fluid communication with the second fluid outlet 113 of the filter cartridge. The filter head 20B can be applied to a filter assembly consisting of a plurality of filters. When the filter head 20B is applied to the filter assembly, one of the first tubular portion 311B and the fourth tubular portion 314B of the filter head 20B can be used as the raw water port of a filter mounted with the filter head 20B, one of the second tubular portion 312B and the fifth tubular portion 315B of the filter head 20B can be used as the first water outlet port of the filter, and one of the third tubular portion 313B and the sixth tubular portion 316B of the filter head 20B can be used as the second water outlet port of the filter; the other one of the first tubular portion 311B and the fourth tubular portion 314B, the other one of the second tubular portion 312B and the fifth tubular portion 315B, and the other one of the third tubular portion 313B and the sixth tubular portion 316B of the filter head 20B can be used as connection ports between the filter and other filters in the filter assembly.

The filter head 20B and the filter having the filter head 20B according to the second modification example of the present disclosure can achieve the same beneficial technical effect as the filter head 20 and the filter 1 according to the first embodiment of the present disclosure, and both can facilitate removal and mounting of the filter cartridge.

The filter head 20, the filter head 20A and the filter head 20B according to the present disclosure can be separately mounted on the filter cartridge 10 to form filters that can be used separately. In the above example, the filter cartridge 10 is a reverse osmosis membrane filter cartridge. However, the present disclosure is not limited thereto. In another example according to the present disclosure, the filter head 20, the filter head 20A and the filter head 20B can also be respectively mounted on other types of filter cartridges. The filter head 20, the filter head 20A and the filter head 20B can be also used in a filter assembly including a plurality of filter cartridges, and can be respectively mounted on corresponding filter cartridges of the filter assembly.

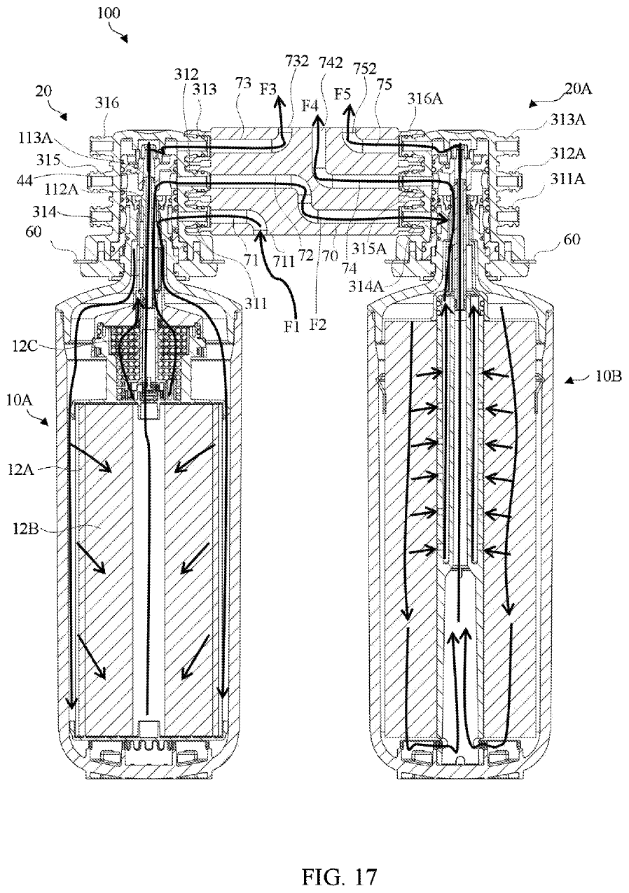

FIG. 17 shows an example of a filter assembly including the filter head according to the present disclosure. As shown in FIG. 17, a filter assembly 100 includes a first filter and a second filter. The first filter and the second filter are in fluid communication with each other by means of a first connecting member 70.

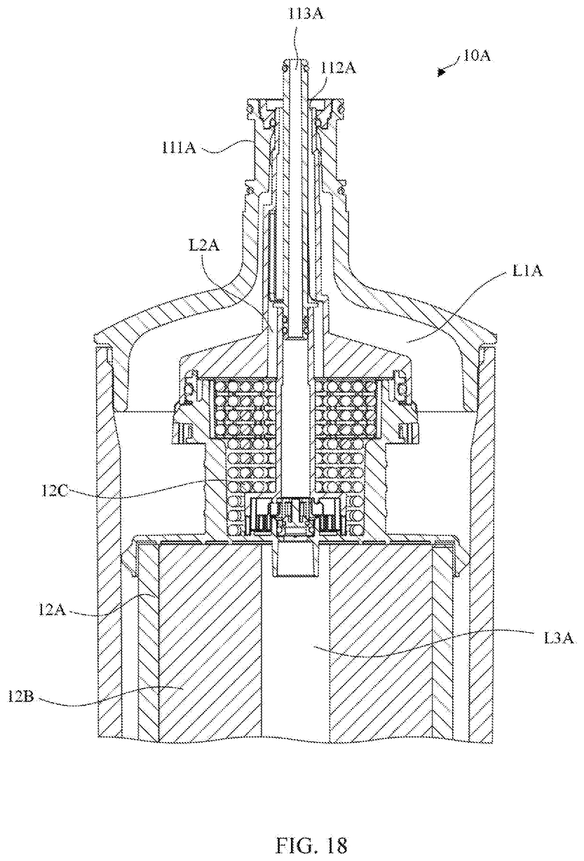

The first filter includes a first filter cartridge 10A and the aforementioned filter head 20. The filter head 20 is mounted on the first filter cartridge 10A. The first filter cartridge 10A is a pre-filtration composite filter cartridge. A housing of the first filter cartridge 10A is the same as the housing 11 of the filter cartridge 10 described above. FIG. 18 shows a partial cross-sectional view of the first filter cartridge 10A, and shows a filtration medium and each fluid channel in the housing of the first filter cartridge 10A. The first filter cartridge 10A includes a first filtration medium 12A, a second filtration medium 12B and a third filtration medium 12C. The first filter cartridge 10A has one fluid inlet or a plurality of fluid inlets 111A spaced apart from each other, and has a first fluid outlet 112A and a second fluid outlet 113A. Raw water enters a raw water channel LIA of the first filter cartridge 10A from the fluid inlet 111A, is filtered by the first filtration medium 12A and the second filtration medium 12B, is then filtered by the third filtration medium 12C, then enters a first outflow channel L2A, and flows out of the filter cartridge 10A from the first fluid outlet 112A. Alternatively, the raw water is filtered by the first filtration medium 12A and the second filtration medium 12B, then flows into a second outflow channel L3A of the filter cartridge 10A, and flows out of the filter cartridge 10A from the second fluid outlet 113A without flowing through the third filtration medium 12C.

As shown in FIG. 17, the filter head 20 is mounted to the first filter cartridge 10A, so that the fluid inlet 111A of the first filter cartridge 10A is in communication with the raw water port (namely, the first tubular portion 311) of the filter head 20; the first fluid outlet 112A of the first filter cartridge 10A is in communication with the first water outlet port (namely, the second tubular portion 312) of the filter head 20; and the second fluid outlet 113A of the first filter cartridge 10A is sealedly mounted in the inner cylindrical portion 44 of the filter head 20 to be in communication with the second water outlet port (namely, the third tubular portion 313) of the filter head 20.

The second filter includes a second filter cartridge 10B and the aforementioned filter head 20A. The second filter cartridge 10B is a reverse osmosis membrane filter cartridge, which is completely the same as the filter cartridge 10 described above. The filter head 20A is mounted on the second filter cartridge 10B. A fluid inlet of the second filter cartridge 10B is in communication with the raw water port (namely, the fourth tubular portion 314A) of the filter head 20A. A first fluid outlet of the second filter cartridge 10B is in communication with the first water outlet port (namely, the fifth tubular portion 315A) of the filter head 20A. A second fluid outlet of the second filter cartridge 10B is in communication with the second water outlet port (namely, the sixth tubular portion 316A) of the filter head 20A.

The first connecting member 70 fluidly connects the first filter to the second filter. Specifically, as shown in FIG. 17, the first connecting member 70 is connected between the filter head 20 and the filter head 20A. The first connecting member 70 is provided with a first fluid channel 71, a second fluid channel 72, a third fluid channel 73, a fourth fluid channel 74 and a fifth fluid channel 75 therein. One end of the first fluid channel 71, one end of the second fluid channel 72 and one end of the third fluid channel 73 are respectively connected to the first tubular portion 311, the second tubular portion 312 and the third tubular portion 313 of the filter head 20. The other end of the first fluid channel 71 is a water inlet 711 of the filter assembly 100, and is connected to the raw water pipeline. Raw water can flow into the first fluid channel 71 from the water inlet 711 and flow into the first filter for filtration through the first tubular portion 311, as indicated by arrow line F1 in FIG. 17. The other end of the second fluid channel 72 is connected to the raw water port (namely, the fourth tubular portion 314A) of the filter head 20A. A fluid filtered by the first filtration medium 12A, the second filtration medium 12B and the third filtration medium 12C of the first filter is used as the raw water of the second filter, and flows into the second filter for further filtration, as indicated by arrow line F2 in FIG. 17. The other end of the third fluid channel 73 is a first water outlet 732 of the filter assembly 100. A fluid (the first outflow fluid) filtered by the first filtration medium 12A and the second filtration medium 12B of the first filter flows into the third fluid channel 73 of the first connecting member 70 from the third tubular portion 313 of the filter head 20, and can flow out from the first water outlet 732 for use, as indicated by arrow line F3 in FIG. 17. One end of the fourth fluid channel 74 and one end of the fifth fluid channel 75 are respectively connected to the fifth tubular portion 315A and the sixth tubular portion 316A of the filter head 20A. The other end of the fourth fluid channel 74 and the other end of the fifth fluid channel 75 are respectively a second water outlet 742 and a third water outlet 752 of the filter assembly 100. The fluid filtered by the first filtration medium 12A, the second filtration medium 12B and the third filtration medium 12C of the first filter flows into the second filter, is treated by the filter cartridge 10B into pure water (the second outflow fluid), flows into the fourth fluid channel 74 of the first connecting member 70 from the fifth tubular portion 315A of the filter head 20A, and flows out from the second water outlet 742 for use, as indicated by arrow line F4 in FIG. 17. Concentrated water (a third outflow fluid) acquired by means of treatment performed by the filter cartridge 10B of the second filter flows into the fifth fluid channel 75 of the first connecting member 70 from the sixth tubular portion 316A of the filter head 20A, and flows out from the third water outlet 752, as indicated by arrow line F5 in FIG. 17.

The filter assembly 100 filters the raw water to acquire three outflow fluids, and the three outflow fluids flow out of the filter assembly 100 respectively by means of the first water outlet 732, the second water outlet 742 and the third water outlet 752.

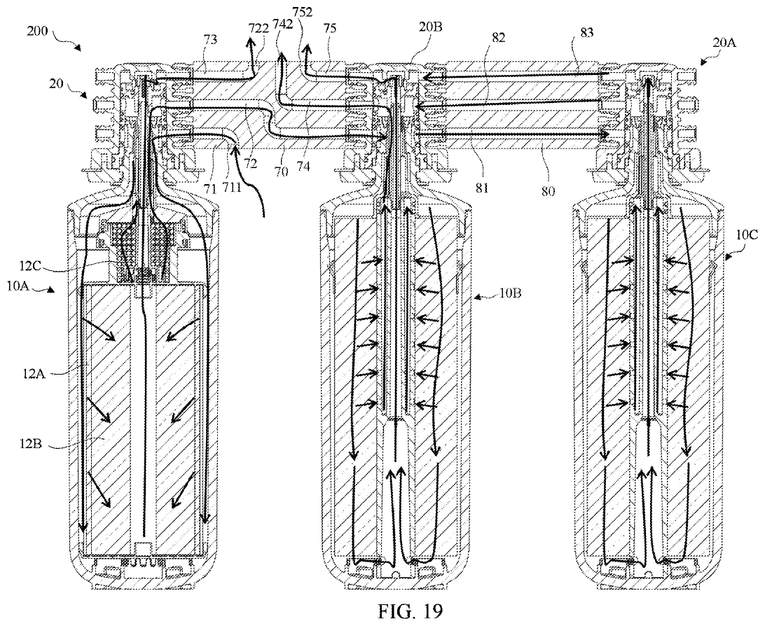

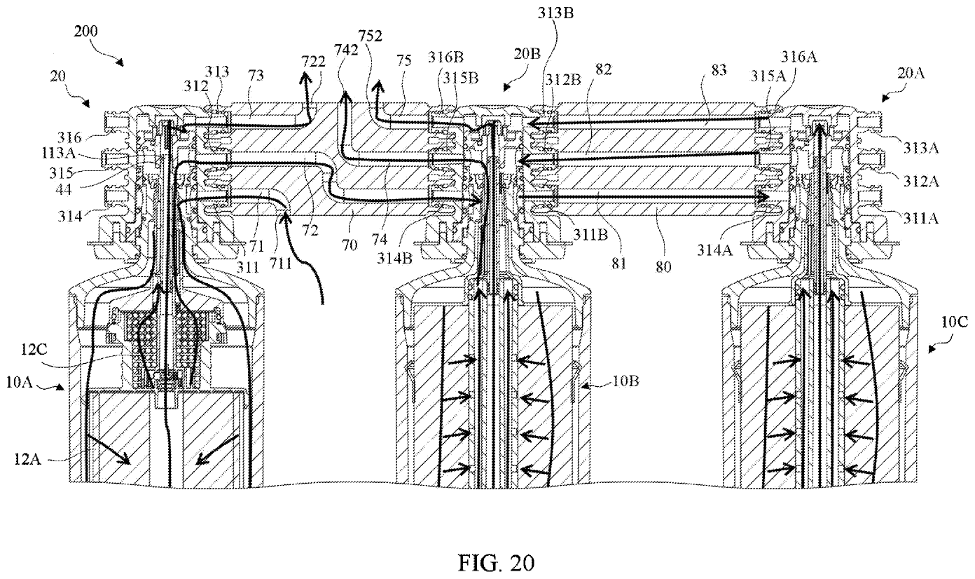

FIG. 19 shows another example of a filter assembly including the filter head according to the present disclosure. FIG. 20 shows a partial enlarged view of FIG. 19. As shown in FIG. 19 and FIG. 20, a filter assembly 200 includes a first filter, a second filter, a third filter and a connecting member fluidly connecting the filters to one another. The first filter of the filter assembly 200 is in fluid communication with the second filter by means of a first connecting member 70, and the third filter of the filter assembly 200 is in fluid communication with the second filter and the first filter by means of a second connecting member 80. The first filter of the filter assembly 200 is the same as the first filter of the filter assembly 100, and the first connecting member 70 of the filter assembly 200 is the same as the first connecting member of the filter assembly 100. The differences between the filter assembly 200 and the filter assembly 100 are as follows: the filter assembly 200 further includes a third filter, and the third filter is fluidly connected to other filters. The following will describe only the difference between the filter assembly 200 and the filter assembly 100.

The second filter of the filter assembly 200 includes a second filter cartridge 10B and the aforementioned filter head 20B. The second filter cartridge 10B of the filter assembly 200 is completely the same as the filter cartridge 10 and the second filter cartridge of the filter assembly 100 described above. The filter head 20B is mounted on the second filter cartridge 10B. A fluid inlet of the second filter cartridge 10B is in communication with the raw water port (namely, one of the first tubular portion 311B and the fourth tubular portion 314B of the filter head 20B) of the filter head 20B. A first fluid outlet of the second filter cartridge 10B is in communication with the first water outlet port (namely, one of the second tubular portion 312B and the fifth tubular portion 315B of the filter head 20B) of the filter head 20B. A second fluid outlet of the second filter cartridge 10B is in communication with the second water outlet port (namely, one of the third tubular portion 313B and the sixth tubular portion 316B of the filter head 20B) of the filter head 20B. In the example shown in the figure, the raw water port of the filter head 20B is the fourth tubular portion 314B, and is connected to an end of the second fluid channel 72 of the first connecting member 70 so as to be in fluid communication with the first water outlet port (i.e., the second tubular portion 312 of the filter head 20) of the filter head 20 of the first filter, so that a fluid filtered by the first filtration medium 12A, the second filtration medium 12B and the third filtration medium 12C of the first filter is the raw water of the second filter cartridge 10B. The first water outlet port of the filter head 20B is the fifth tubular portion 315B, and is connected to an end of the fourth fluid channel 74 of the first connecting member 70 so as to be in fluid communication with a second water outlet 742 of the filter assembly 200, so that pure water acquired by means of further treatment performed by the second filter cartridge 10B is used as the second outflow fluid and flows out from the second water outlet 742 of the filter assembly 200. The second water outlet port of the filter head 20B is the sixth tubular portion 316B, and is connected to an end of the fifth fluid channel 75 of the first connecting member 70 so as to be in fluid communication with a third water outlet 752 of the filter assembly 200, so that concentrated water acquired by means of further treatment performed by the second filter cartridge 10B is used as the third outflow fluid and flows out from the third water outlet 752 of the filter assembly 200. The first tubular portion 311B, the second tubular portion 312B and the third tubular portion 313B of the filter head 20B are connection ports between the filter head 20B and the third filter.

The third filter of the filter assembly 200 includes a third filter cartridge 10C and the aforementioned filter head 20A. The third filter cartridge 10C of the filter assembly 200 is completely the same as the second filter cartridge 10B. The filter head 20A is mounted on the third filter cartridge 10C. A fluid inlet of the third filter cartridge 10C is in communication with the raw water port (namely, the fourth tubular portion 314A of the filter head 20A) of the filter head 20A. A first fluid outlet of the third filter cartridge 10C is in communication with the first water outlet port (namely, the fifth tubular portion 315A of the filter head 20A) of the filter head 20A. A second fluid outlet of the third filter cartridge 10C is in communication with the second water outlet port (namely, the sixth tubular portion 316A of the filter head 20A) of the filter head 20A. The third filter is in fluid communication with the second filter and the first filter by means of the second connecting member 80.

The second connecting member 80 is configured to fluidly connect the filter head 20A of the third filter to the filter head 20B of the second filter, so that the filter head 20A of the third filter can be in fluid communication with the first connecting member 70 and the first filter. The second connecting member 80 is provided with a first fluid channel 81, a second fluid channel 82 and a third fluid channel 83. As shown in FIG. 20, one end of the first fluid channel 81 is connected to the first tubular portion 311B of the filter head 20B of the second filter, and the other end of the first fluid channel 81 is connected to the fourth tubular portion 314A of the filter head 20A of the third filter. One end of the second fluid channel 82 is connected to the second tubular portion 312B of the filter head 20B of the second filter, and the other end of the second fluid channel 82 is connected to the fifth tubular portion 315A of the filter head 20A of the third filter. One end of the third fluid channel 83 is connected to the third tubular portion 313B of the filter head 20B of the second filter, and the other end of the third fluid channel 83 is connected to the sixth tubular portion 316A of the filter head 20A of the third filter.

The fluid filtered by the first filtration medium 12A, the second filtration medium 12B and the third filtration medium 12C of the first filter flows into the fourth tubular portion 314B of the filter head 20B of the second filter by means of the second fluid channel 72 of the first connecting member 70, and enters the inner cavity of the valve 40 by means of the third through hole 413 of the valve 40 of the filter head 20B. Part of the filtered fluid entering the inner cavity of the valve 40 of the filter head 20B flows into the second filter cartridge 10B by means of the fluid inlet of the second filter cartridge 10B so as to be further filtered by the second filter cartridge 10B, and the other part flows into the first tubular portion 311B of the filter head 20B by means of the first through hole 411 of the valve 40 of the filter head 20B to flow into the first fluid channel 81 of the second connecting member 80 and flow into the third filter by means of the fourth tubular portion 314A of the filter head 20A so as to be further filtered by the third filter cartridge 10C. Therefore, the fluid filtered by the first filtration medium 12A, the second filtration medium 12B and the third filtration medium 12C of the first filter is the raw water of the second filter and the third filter.

The pure water acquired by means of treatment performed by the second filter cartridge 10B of the second filter is used as the second outflow fluid, flows into the fourth fluid channel 74 of the first connecting member 70 from the fifth tubular portion 315B of the filter head 20B, and flows out from the second water outlet 742 of the filter assembly 200. The concentrated water acquired by means of treatment performed by the second filter cartridge 10B of the second filter is used as the third outflow fluid, flows into the fifth fluid channel 75 of the first connecting member 70 from the sixth tubular portion 316B of the filter head 20B, and flows out from the third water outlet 752 of the filter assembly 200.

The raw water flowing into the third filter from the fourth tubular portion 314A of the filter head 20A is treated by the third filter cartridge 10C of the third filter into pure water, flows from the fifth tubular portion 315A of the filter head 20A into the valve 40 of the filter head 20B by means of the second fluid channel 82 of the second connecting member 80, the second tubular portion 312B of the filter head 20B and the second through hole 412 of the valve 40 of the filter head 20B, flows into the fourth fluid channel 74 of the first connecting member 70 by means of the fourth through hole 414 of the valve 40 of the filter head 20B and the fifth tubular portion 315B, and flows out from the second water outlet 742 of the filter assembly 200. The concentrated water acquired by means of treatment performed by the third filter cartridge 10C of the third filter flows from the sixth tubular portion 316A of the filter head 20A into the housing body 31 of the filter head 20B by means of the third fluid channel 83 of the second connecting member 80 and the third tubular portion 313B of the filter head 20B, flows into the fifth fluid channel 75 of the first connecting member 70 by means of the sixth tubular portion 316B of the filter head 20B, and flows out from the third water outlet 752 of the filter assembly 200.

Therefore, the pure water acquired by means of treatment performed by the second filter cartridge 10B of the second filter and the pure water acquired by means of treatment performed by the third filter cartridge 10C of the third filter are the second outflow fluid of the filter assembly 200 and flow out from the second water outlet 742, and the concentrated water acquired by means of treatment performed by the second filter cartridge 10B of the second filter and the concentrated water acquired by means of treatment performed by the third filter cartridge 10C of the third filter are the third outflow 20) fluid of the filter assembly 200 and flow out from the third water outlet 752.

In the filter assembly 200 shown in the figure, the second filter cartridge 10B and the third filter cartridge 10C are completely the same filter cartridge, and the second filter and the third filter are connected in parallel. However, the present disclosure is not limited thereto. In another example of the filter assembly according to present disclosure, the second filter and the third filter can also be connected in series. For example, in an example, the second tubular portion 312B of the filter head 20B of the second filter may be connected to the raw water port of the third filter so that the fluid acquired by means of treatment performed by the second filter can be further treated by the third filter, and correspondingly, the fifth tubular portion 315A and the sixth tubular portion 316A of the third filter are fluidly connected to another water outlet of the filter assembly to provide outflow fluids further filtered at different levels so as to provide more selections.

By means of the application of the present disclosure in filtration of municipal tap water, the above descriptions illustrate the filter head, the filter and the filter assembly according to the preferred embodiments of the present disclosure. However, the present disclosure is not limited to the above preferred embodiments. Modifications can be made to the above preferred embodiments on the basis of the ideas of the present disclosure, and these modifications all fall within the scope of the present disclosure.

In the filter head of the above preferred example, the first inner cylinder portion 441 has a top wall 445; the first opening portion 443 and the second opening portion 444 are provided on the circumferential wall and the top wall of the first inner cylinder portion 441; and the annular wall 33 of the filter head housing 30 sealedly engages with the first inner cylinder portion 441 of the valve 40, and no seal is provided between the two. However, the present disclosure is not limited thereto. In another example according to the present disclosure, the first inner cylinder portion 441 may not have the top wall 445; an opening portion may be provided on the circumferential wall of the first inner cylinder portion; and a seal may also be provided around the opening portion on the circumferential wall of the first inner cylinder portion if a mounting space permits so as to provide better sealing.

In the filter head of the above preferred example, all of the raw water port P1, the first water outlet port P2 and the second water outlet port P3 are located on the same side, and are provided by tubular portions on the same side. However, the present disclosure is not limited thereto. In another example according to the present disclosure, one of the raw water port P1, the first water outlet port P2 and the second water outlet port P3 may be disposed, according to requirements, to be on a side different from a side on which the other ports are located. For example, in an example, the raw water port P1 is provided by the first tubular portion 311, and the first water outlet port P2 and the second water outlet port P3 may be respectively provided by the fifth tubular portion 315 and the sixth tubular portion 316. In this case, the first tubular portion 311, the fifth tubular portion 315 and the sixth tubular portion 316 are in communication with the inner cavity of the filter head housing 30.

In the filter of the above preferred example, the filter head is applied to a filter cartridge having two fluid outlets. However, the present disclosure is not limited thereto. The filter head according to the present disclosure may also be applied to a filter cartridge having one fluid outlet. In this application, the fluid outlet of the filter cartridge may be configured to be in communication with one of the first water outlet port and the second water outlet port of the filter head.

In the filter assembly of the above preferred example, all of the water inlet 711, the first water outlet 732, the second water outlet 742 and the third water outlet 752 of the filter assembly are provided on the first connecting member 70. However, the present disclosure is not limited thereto. In another example according to the present disclosure, other arrangements may also be used for the water inlet 711, the first water outlet 732, the second water outlet 742 and the third water outlet 752 of the filter assembly. For example, in a modification example of the filter assembly shown in FIG. 17 and the filter assembly shown in FIG. 19, the second tubular portion 312A and the third tubular portion 313A of the filter head 20A may be configured to be in communication with the inner cavity of the filter head housing, and are respectively configured to be the second water outlet and the third water outlet of the filter assembly. In this modification, the fifth tubular portion 315A and the sixth tubular portion 316A of the filter head 20A may be configured not to be in communication with the inner cavity of the filter head housing. In another modification example of the filter assembly shown in FIG. 19, the second water outlet and the third water outlet of the filter assembly may be provided on the second connecting member 80, and correspondingly, the fifth tubular portion 315B and the sixth tubular portion 316B of the filter head 20B of the second filter may be configured not to be in communication with the inner cavity of the filter head housing of the filter head 20B.

In the filter assembly 200 of the above preferred example, the filter head of the third filter is connected to the filter head 20B of the second filter by means of the second connecting member 80, and the filtered fluid flowing out from the first water outlet port of the first filter flows into the raw water port of the filter head 21A of the third filter by means of the filter head 20B of the second filter. However, the present disclosure is not limited thereto. In another example according to the present disclosure, the fifth tubular 30 portion 315 of the filter head 20 of the first filter may be configured to be in communication with the inner cavity of the filter head housing of the filter head 20, and the raw water port of the filter head 20A of the third filter is connected to the fifth tubular portion 315 of the filter head 20 of the first filter. In this modification example, the first tubular portion 311B of the filter head 20B of the second filter may be configured not to be in communication with the inner cavity of the filter head housing.

In the filter assembly of the above preferred example, the filter heads of the filter assembly are in communication with each other by means of the fluid channels in the first connecting member 70 and the second connecting member 80. However, the present disclosure is not limited thereto. In another example according to the present disclosure, the filter heads of the filter assembly can be in communication with each other by means of corresponding fluid pipes. The filter assembly according to the present disclosure may be provided with more filters according to requirements, for example, four filters may be provided.

Herein, the exemplary embodiments of the present disclosure are described in detail with reference to the application of the filter head, the filter having the filter head and the filter assembly according to the present disclosure in the field of filtration of drinking water. However, it should be understood that the present disclosure is not limited to the specific embodiments described and illustrated above in detail. Those skilled in the art can make various variations and variants of the present disclosure without departing from the gist and scope of the present disclosure. All these variations and variants fall within the scope of the present disclosure. In addition, all members described herein can be replaced with other technically equivalent members.

1. A filter head (20, 20A, 20B), comprising:
a filter head housing (30, 30A, 30B) comprising a hollow housing body (31, 31A, 31B);
a valve (40) mounted in an inner cavity of the housing body (31, 31A, 31B), wherein the valve (40) comprises a hollow valve body (41); an inner cavity of the valve body (41) is to accommodate a fluid inlet (111) and a fluid outlet of a filter cartridge (10); and
a filter head base (50) mounted to the filter head housing (30, 30A, 30B) so as to confine the valve (40) in the filter head housing (30, 30A, 30B);
and characterized in that
the housing body (31, 31A, 31B) is provided with a raw water port (P1), a first water outlet port (P2) and a second water outlet port (P3) in communication with the inner cavity of the housing body (31, 31A, 31B); and
the valve (40) is configured so that the valve (40) can rotate relative to the filter head housing (30, 30A, 30B) to an open position or a closed position; in the open position, the inner cavity of the valve body (41) is in fluid communication with the raw water port (P1), the first water outlet port (P2) and the second water outlet port (P3), and in the closed position, the inner cavity of the valve body (41) is not in fluid communication with any one of the raw water port (P1), the first water outlet port (P2) and the second water outlet port (P3).

2. The filter head (20, 20A, 20B) according to claim 1, wherein a circumferential wall of the valve body (41) is provided with a first group of through holes and a second group of through holes spaced apart from each other in an axial direction of the valve (40); a transverse wall (43) of the valve body (41) is provided with an inner cylindrical portion (44); the inner cylindrical portion (44) axially extends through the transverse wall (43), and has a first inner cylinder portion (441) located axially above the transverse wall (43); the first inner cylinder portion (441) is provided with an opening portion;
in the open position, one of the first group of through holes is in fluid communication with the raw water port (P1), one of the second group of through holes is in fluid communication with the first water outlet port (P2), and the opening portion is in fluid communication with the second water outlet port (P3); and
in the closed position, none of the first group of through holes is in fluid communication with the raw water port (P1), none of the second group of through holes is in fluid communication with the first water outlet port (P2), and the opening portion is not in fluid communication with the second water outlet port (P3).

3. The filter head (20, 20A, 20B) according to claim 2, wherein the housing body (31, 31A, 31B) is further provided with an annular wall (33) axially extending from a top wall (317) of the housing body (31, 31A, 31B) into the inner cavity of the housing body (31, 31A, 31B); an axial end portion of the annular wall (33) is provided with a notch; the annular wall (33) sealedly engages with the first inner cylinder portion (441);
in the open position, the opening portion is in fluid communication with the second water outlet port (P3) by means of the notch; and
in the closed position, the opening portion is completely blocked by the annular wall (33).

4. The filter head (20, 20A, 20B) according to claim 3, wherein one of the housing body (31, 31A, 31B) and the valve body (41) is provided with a first position-limiting portion, and the other one of the housing body (31, 31A, 31B) and the valve body (41) is provided with a second position-limiting portion; the first position-limiting portion and the second position-limiting portion jointly define a rotation range of the valve (40) relative to the filter head housing (30, 30A, 30B).

5. The filter head (20, 20A, 20B) according to claim 4, wherein
the opening portion comprises a first opening portion (443) and a second opening portion (444) spaced apart circumferentially;
the notch comprises a first notch (335) and a second notch (336) spaced apart circumferentially, so that a first curved wall (331) and a second curved wall (332) spaced apart from each other circumferentially are formed on the axial end portion of the annular wall (33);
in the open position, the first opening portion (443) and the second opening portion (444) are in fluid communication with the second water outlet port (P3) respectively by means of the first notch (335) and the second notch (336); and
in the closed position, the first opening portion (443) and the second opening portion (444) are respectively completely blocked by the first curved wall (331) and the second curved wall (332).

6. The filter head (20, 20A, 20B) according to claim 5, wherein the first position-limiting portion is a position-limiting protrusion (333) provided on an axial end portion of the first curved wall (331), and the second position-limiting portion is a position-limiting recess (431) provided on the transverse wall (43) of the valve body (41).

7. The filter head (20, 20A, 20B) according to claim 2, wherein an annular first seal (SI), an annular second seal (S2) and an annular third seal (S3) are provided between the circumferential wall of the valve body (41) and a circumferential wall of the housing body (31, 31A, 31B); the first seal (SI) is located axially below the first group of through holes; the second seal (S2) is located between the first group of through holes and the second group of through holes; and the third seal (S3) is provided axially above the second group of through holes, and is located axially below the second water outlet port (P3).

8. The filter head (20, 20A, 20B) according to claim 2, wherein each through hole of the first group of through holes and the second group of through holes is provided with an annular seal therearound.

9. The filter head (20, 20A, 20B) according to claim 2, wherein the filter head housing (30, 30A, 30B) further comprises a housing flange (32, 32A, 32B); the housing flange (32, 32A, 32B) is located on a radial outer side of the housing body (31, 31A, 31B); a housing step portion (321) is formed between the housing body (31, 31A, 31B) and the housing flange (32, 32A, 32B) in an inner cavity of the filter head housing (30, 30A, 30B); and the housing step portion (321) and the filter head base (50) jointly maintain an axial position of the valve (40).

10. The filter head (20, 20A, 20B) according to claim 9, wherein the valve (40) further comprises a valve flange (42); the valve flange (42) is located on a radial outer side of the valve body (41); a valve step portion (421) is formed between the valve body (41) and the valve flange (42) in an inner cavity of the valve (40), wherein the valve flange (42) is mounted between the filter head base (50) and the housing step portion (321).

11. The filter head (20, 20A, 20B) according to claim 10, wherein an inner surface of a circumferential wall of the valve flange (42) is provided with a protruding portion (422), and the protruding portion (422) is configured to be operable so as to cause the valve (40) to rotate relative to the filter head housing (30, 30A, 30B).

12. The filter head (20, 20A, 20B) according to claim 1, wherein the housing body (31, 31A, 31B) is provided with a first group of tubular portions, a second group of tubular portions and a third group of tubular portions spaced apart from each other in an axial direction of the housing body (31, 31A, 31B); one of the first group of tubular portions forms the raw water port (P1); one of the second group of tubular portions forms the first water outlet port (P2); and one of the third group of tubular portions forms the second water outlet port (P3).

13. The filter head (20, 20A, 20B) according to claim 12, wherein the raw water port (P1), the first water outlet port (P2) and the second water outlet port (P3) are axially aligned with each other.

14. The filter head (20, 20A, 20B) according to claim 12, wherein an outer circumferential wall of the housing body (31, 31A, 31B) is provided with a rib portion circumferentially extending thereon.

15. The filter head (20, 20A, 20B) according to claim 14, wherein the rib portion comprises a first annular rib (318) and a second annular rib (319), the first annular rib (318) is provided between the first group of tubular portions and the second group of tubular portions, and the second annular rib (319) is provided between the second group of tubular portions and the third group of tubular portions; and/or
the rib portion comprises curved ribs circumferentially extending on the outer circumferential wall of the housing body between the tubular portions of each group of the first group of tubular portions, the second group of tubular portions and the third tubular portions.

16. The filter head (20, 20A, 20B) according to claim 14, wherein the first group of tubular portions, the second group of tubular portions, the third tubular portions and the rib portion of the housing body are integrally formed by means of injection molding.

17. A filter (1) comprising a filter cartridge (10), and the filter cartridge (10) being provided with a fluid inlet (111) and a fluid outlet; and characterized in that the filter further comprises the filter head (20, 20A, 20B) according to claim 1,
wherein the fluid inlet (111) and the fluid outlet of the filter cartridge (10) are mounted in the inner cavity of the valve body (41) of the filter head (20, 20A, 20B); the fluid inlet (111) is in fluid communication with the raw water port (P1); and the fluid outlet is in communication with one or both of the first water outlet port (P2) and the second water outlet port (P3).

18. The filter (1) according to claim 17, wherein the fluid outlet comprises a first fluid outlet (112) and a second fluid outlet (113); the first fluid outlet (112) is in fluid communication with the first water outlet port (P2); and the second fluid outlet (113) is in fluid communication with the second water outlet port (P3).

19. The filter (1) according to claim 17, wherein the filter cartridge (10) is provided with a retaining recess (115), and the retaining recess (115) engages with the protruding portion (422) of the valve (40) so that the valve (40) can rotate with the filter cartridge (10) to the open position or the closed position.

20. The filter (1) according to claim 19, wherein the filter cartridge (10) is provided with a mounting portion (114); an inner wall of the filter head base (50) is provided with a retaining portion (53); when the valve (40) rotates with the filter cartridge (10), the mounting portion (114) moves along the retaining portion (53);
in the open position, the mounting portion (114) is confined between the retaining portion (53) and a valve step portion (421) of the valve (40); and in the closed position, the mounting portion (114) leaves the retaining portion (53).

21. The filter (1) according to claim 20, wherein the retaining recess (115) is provided on the mounting portion (114).

22. A filter assembly (100, 200) comprising a plurality of filters according to claim 17, wherein the plurality of filters are fluidly connected to each other.

23. The filter assembly according to claim 22, wherein the plurality of filters comprises a first filter and a second filter, and the filter assembly is provided with:
a water inlet connected to a raw water port of the first filter;
a first water outlet connected to a second water outlet port of the first filter;
a second water outlet connected to a first water outlet port of the second filter; and
a third water outlet connected to a second water outlet port of the second filter,
wherein a first water outlet port of the first filter is connected to a raw water port of the second filter.

24. The filter assembly according to claim 23, wherein the plurality of filters further comprises a third filter.

25. The filter assembly according to claim 24, wherein one of the raw water port, the first water outlet port and the second water outlet port of the second filter is in fluid communication with a raw water port of the third filter.

26. The filter assembly according to claim 25, wherein the raw water port of the second filter is in fluid communication with the raw water port of the third filter; a first water outlet port of the third filter is connected to the second water outlet; a second water outlet port of the third filter is connected to the third water outlet.

27. The filter assembly according to claim 23, wherein a filter cartridge of the first filter is a pre-filtration composite filter cartridge, and a filter cartridge of the second filter is a reverse osmosis membrane filter cartridge.
